(19) United States
(12) Patent Application Publication
(10) Pub. No.: US 2020/0126174 A1
(43) Pub. Date: Apr. 23, 2020

(54) SOCIAL MEDIA ANALYTICS FOR EMERGENCY MANAGEMENT

(71) Applicant: RapidSOS, Inc., New York, NY (US)

(72) Inventors: Shane HALSE, State College, PA (US); Patrick DESPRES-GALLAGHER, Palo Alto, CA (US); Reinhard EKL, New York, NY (US); Michael John MARTIN, Long Island City, NY (US); Nicholas Edward HORELIK, Long Island City, NY (US)

(21) Appl. No.: 16/537,377

(22) Filed: Aug. 9, 2019

Related U.S. Application Data
(60) Provisional application No. 62/717,645, filed on Aug. 10, 2018.

(51) Int. Cl. G06Q 50/26; G06Q 50/00; G06F 40/295; G06F 40/253; G06F 40/30

(52) U.S. Cl. CPC G06Q 50/265; G06Q 50/01; G06F 40/30; G06F 40/253; G06F 40/295

(57) ABSTRACT

Described herein are systems, servers, devices, methods, and media for providing relevant social media data for emergency response. In some embodiments, the method comprises accessing and analyzing a social media feed to identify the relevant social media data including relevant posts and transmitting the said social media data to an emergency service provider (ESP). In some embodiments, analyzing involves geo-bounding, keyword searches and natural language processing (NLP).

### BACKGROUND

In some emergency situations, traditional means for calling emergency can often become congested and overloaded. For example, in Hurricane Harvey, 911 traffic spiked considerably causing 45-minute wait times in some instances. In such disasters, it can be particularly challenging for individuals in an emergency to wait on hold (rapidly changing conditions, dying cell phone batteries, rising flood waters, limited cell receptivity, etc.).

### SUMMARY

With the rise of social media websites, users have become accustomed to sharing various aspects of their lives on such forums. During emergency situations, users may turn to social media for help such as when they are unable to call for emergency help. However, a post on social media may not reach the proper authorities, and the emergency help may not be dispatched. In addition, many emergency dispatch centers (e.g., Public Safety Answering Points or PSAPs) do not have capacity to analyze and display the relevant information about the emergency posted on social media websites.

One advantage provided by the systems, applications, servers, devices, methods, and media of the instant application is the ability to access a jurisdictional awareness view for Emergency Service Providers (ESPs). In some embodiments, the jurisdictional awareness view enables an ESP (e.g., a PSAP) to view ongoing and optionally recently received emergency alerts within one or more geofenced jurisdictions. In some embodiments, the jurisdictional management view displays an alert queue (also referred to as a “list of alerts”) with numerous emergency alerts associated with a user (e.g., a social media profile) and a location for each emergency alert. In some embodiments, the location associated with an alert is updated in real time. In some embodiments, the jurisdictional management view displays the location of available emergency services within a variable proximity to a location associated with an incident. In some embodiments, the ESP is enabled to coordinate the dispatch of emergency responders to emergency callers, so as to reduce response times and improve the allocation of resources.

Disclosed herein is a method producing relevant social media data for emergency response by an emergency assistance system (EAS), the method comprising: (a) accessing a social media feed comprising a plurality of posts published on a social media network by at least one user; (b) analyzing the social media feed to identify the relevant social media data determined to be pertinent to at least one current emergency situation, wherein the relevant social media data comprises relevant posts; and (c) transmitting the relevant social media data comprising the relevant posts to an emergency service provider (ESP). In some embodiments, the analyzing comprises: (i) filtering the social media feed using geo-bounding and keywords to generate a filtered feed comprising filtered posts; and (ii) processing the filtered feed to produce the relevant social media data by analyzing the filtered posts to identify relevant posts based on one or more of bots, emotion, categorization, location, named entity recognition (NER), intensity, trend, veracity, tagging, and part-of-speech (POS) tagging. In some embodiments, the method further comprises NLP for analyzing the social media feed in step (b). In some embodiments, the method further comprises: (d) receiving one or more actions by an ESP user in relation to the relevant posts; and (e) using the actions by the ESP user as feedback for improving the step of analyzing the social media feed in step (b). In some embodiments, the one or more actions by the ESP user comprises selecting the relevant posts for forwarding to one or more ESP users responding to the at least one current emergency situation. In some embodiments, the one or more actions by the ESP user comprises linking at least one of the relevant posts to one or more incident IDs of the at least one current emergency situation for CAD integration. In some embodiments, the one or more actions by the ESP user comprises selecting at least one of the relevant posts, wherein an I-frame is generated and displayed to one or more members of the ESP. In some embodiments, the method further comprises analyzing the social media feed in step (b) comprises supervised learning. In some embodiments, the method further comprises the one or more actions by the ESP user comprises selecting at least one of the relevant posts, wherein an I-frame is generated and displayed to one or more members of the ESP. In some embodiments, the I-frame is accessible on responder devices by emergency responders responding to the at least one current emergency situation. In some embodiments, the method further comprises the one or more actions by the ESP user comprises selecting relevant social media data and generating a new incident ID. In some embodiments, the new incident ID is associated with a mass casualty incident. In some embodiments, a social media analyst selects the relevant social media data for forwarding to at least one of a call taker, dispatcher, or responder who is responding to the at least one current emergency situation. In some embodiments, the method further comprises geo-bounding comprises analyzing at least one of check-in location, device-based location services, IP address, user selected location, or stored address. In some embodiments, the method comprises analyzing the social media feed in (b) comprises natural language processing (NLP) of the social media feed. In some embodiments, the method further comprises natural language processing (NLP) for parsing a filtered post. In some embodiments, the method further comprises natural language processing (NLP) for part-of-speech tagging words in a filtered post. In some embodiments, the method further comprises natural language processing (NLP) for performing text summarization on a filtered post. In some embodiments, filtering the social media feed in step (b)(ii) comprises geo-bounding the social media feed to a geo-bounded area corresponding to the geographical jurisdiction of the organization of the ESP user, wherein the ESP user is a member of a PSAP. In some embodiments, the method further comprises filtering the social media feed in step (b)(ii) comprises using one or more keywords selected from “shooter”, “fire”, “flood”, “gun”, “violence”, “help”, “911”, “112”, “999”, “000”, “emergency”, “protest”, “punch”, “assault”, “heart attack”, “medical”, “broken”, “explosion”, “trapped”, “sinking”, “hurt”, “pain”, “suffering”, “storm”, “lighting”, “gas”, “attack”, “poison”, “lost”, “fell”, “fallen”, “smashed”, “mangled”, “earthquake”, “tsunami”, “ambulance”, “police”, “EMT”, “failure”, “FEMA”, and “disaster.” In some embodiment, the method further comprises filtering for geo-bounding in step (b)(i) using location data obtained from a social media network. In some embodiments, the social media data comprises one or more of keyword search results, relevant posts, trending news or topics, hashtag tracking, campaign tracking, shares, reach, engagement, mentions, sentiment analysis, user tagging, image recognition, face recognition, virality, and influencer tracking. In some embodiments, the social media data comprises metrics such as shares, likes, mentions, impression, hashtag usage, offensive language, URL clicks, keyword analysis, unique users, followers, new followers, and comments. In some embodiments, the social media data comprises analytics such as engagement, impressions, likes, post reach, reactions, unlikes, engagement rate, followers, link clicks, mentions, profile visits, retweets, replies, tweet impressions, and tweets. In some embodiments, the relevant posts comprise information associated with at least one current emergency comprising one or more of photos, video feed, audio, latitude-longitude coordinates, physical address, check-ins, chat messages, and status updates. In some embodiments, the method further comprises: (A) receiving an emergency data request from the ESP; and (B) securely transmitting the emergency data associated with the emergency alert to the ESP in response to receiving the emergency data request, wherein the emergency data comprises relevant posts. In some embodiments, transmitting the relevant social media data comprising the relevant posts to an ESP further comprises: (A) the emergency data request comprises credentials associated with the ESP; and (B) verifying the credentials associated with the ESP before securely transmitting the emergency data, wherein the emergency data comprises relevant posts. In some embodiments, the method further comprises detecting mass emergencies, wherein the relevant social media data identifies mass emergencies by one or more of trending topics or hashtags, social media content volume and key word sentiment severity. In some embodiments, the method further comprises determining the affected area of the mass emergency by analyzing location of relevant posts.

Disclosed herein is an emergency assistance system (EAS) comprising a processor, a memory, and non-transitory computer readable medium including instructions executable by the processor to create a software application for producing relevant social media data for emergency response, the application comprising: (a) a software module accessing a social media feed comprising a plurality of posts published on a social media network by at least one user; (b) a software module analyzing the social media feed to identify the relevant social media data determined to be pertinent to at least one current emergency situation, wherein the relevant social media data comprises relevant posts; and (c) a software module transmitting the relevant social media data comprising the relevant posts to an emergency service provider (ESP). In some embodiments, the analyzing comprises: (i) filtering the social media feed using geo-bounding and keywords to generate a filtered feed comprising filtered posts; and (ii) processing the filtered feed to produce the relevant social media data by analyzing the filtered posts to identify relevant posts based on one or more of bots, emotion, categorization, location, named entity recognition (NER), intensity, trend, veracity, tagging, and part-of-speech (POS) tagging. In some embodiments, natural language processing (NLP) is utilized for analyzing the social media feed in step (b). In some embodiments, the application further comprises: (d) a software module receiving one or more actions by an ESP user in relation to the relevant posts; and (e) a software module using the actions by the ESP user as feedback for improving the step of analyzing the social media feed in step (b). In some embodiments, the one or more actions by the ESP user comprises selecting the relevant posts for forwarding to one or more ESP users responding to the at least one current emergency situation. In some embodiments, the one or more actions by the ESP user comprises linking at least one of the relevant posts to one or more incident IDs of the at least one current emergency situation for CAD integration. In some embodiments, analyzing the social media feed in step (b) comprises supervised learning. In some embodiments, the one or more actions by the ESP user comprises selecting at least one of the relevant posts, wherein an I-frame is generated and displayed to one or more members of the ESP. In some embodiments, the I-frame is accessible on responder devices by emergency responders responding to the at least one current emergency situation. In some embodiments, the one or more actions by the ESP user comprises selecting relevant social media data and generating a new incident ID. In some embodiments, the new incident ID is associated with a mass casualty incident. In some embodiments, a social media analyst selects the relevant social media data for forwarding to at least one of a call taker, dispatcher, or responder who is responding to the at least one current emergency situation. In some embodiments, geo-bounding comprises analyzing at least one of check-in location, device-based location services, IP address, user selected location, or stored address. In some embodiments, analyzing the social media feed in (b) comprises natural language processing of the social media feed. In some embodiments, natural language processing (NLP) comprises parsing a filtered post. In some embodiments, natural language processing (NLP) comprises part-of-speech tagging words in a filtered post. In some embodiments, natural language processing (NLP) comprises performing text summarization on a filtered post. In some embodiments, filtering the social media feed in step (b)(ii) comprises geo-bounding the social media feed to a geo-bounded area corresponding to the geographical jurisdiction of the organization of the ESP user, wherein the ESP user is a member of a PSAP. In some embodiments, filtering the social media feed in step (b)(ii) comprises using one or more keywords selected from “shooter”, “fire”, “flood”, “gun”, “violence”, “help”, “911”, “112”, “999”, “000”, “emergency”, “protest”, “punch”, “assault”, “heart attack”, “medical”, “broken”, “explosion”, “trapped”, “sinking”, “hurt”, “pain”, “suffering”, “storm”, “lighting”, “gas”, “attack”, “poison”, “lost”, “fell”, “fallen”, “smashed”, “mangled”, “earthquake”, “tsunami”, “ambulance”, “police”, “EMT”, “failure”, “FEMA”, and “disaster.” In some embodiments, the filtering for geo-bounding in step (b)(i) using location data obtained from a social media network. In some embodiments, the social media data comprises one or more of keyword search results, relevant posts, trending news or topics, hashtag tracking, campaign tracking, shares, reach, engagement, mentions, sentiment analysis, user tagging, image recognition, face recognition, virality, and influencer tracking. In some embodiments, the social media data comprises metrics such as shares, likes, mentions, impression, hashtag usage, offensive language, URL clicks, keyword analysis, unique users, followers, new followers, and comments. In some embodiments, the social media data comprises analytics such as engagement, impressions, likes, post reach, reactions, unlikes, engagement rate, followers, link clicks, mentions, profile visits, retweets, replies, tweet impressions, and tweets. In some embodiments, the relevant posts comprise information associated with at least one current emergency comprising one or more of photos, video feed, audio, latitude-longitude coordinates, physical address, check-ins, chat messages, and status updates. In some embodiments, the application comprises: (a) a software module receiving an emergency data request from the ESP; and (b) a software module securely transmitting the emergency data associated with the emergency alert to the ESP in response to receiving the emergency data request, wherein the emergency data comprises relevant posts. In some embodiments, transmitting the relevant social media data comprising the relevant posts to an ESP further comprises: (a) the emergency data request comprises credentials associated with the ESP; and (b) verifying the credentials associated with the ESP before securely transmitting the emergency data, wherein the emergency data comprises relevant posts. In some embodiments, the application further comprises a software module detecting mass emergencies, wherein the relevant social media data identifies mass emergencies by one or more of trending topics or hashtags, social media content volume and key word sentiment severity. In some embodiments, the application further comprises a software module determining an affected area of the mass emergency by analyzing location of relevant posts.

Disclosed herein, is non-transitory computer readable medium comprising instructions executable by a processor to create an application for producing relevant social media data for emergency response by an emergency assistance system (EAS), the application comprising: (a) a software module accessing a social media feed comprising a plurality of posts published on a social media network by at least one user; (b) a software module analyzing the social media feed to identify the relevant social media data determined to be pertinent to at least one current emergency situation, wherein the relevant social media data comprises relevant posts; and (c) a software module transmitting the relevant social media data comprising the relevant posts to an emergency service provider (ESP). In some embodiments, the analyzing comprises: (i) filtering the social media feed using geo-bounding and keywords to generate a filtered feed comprising filtered posts; and (ii) processing the filtered feed to produce the relevant social media data by analyzing the filtered posts to identify relevant posts based on one or more of bots, emotion, categorization, location, named entity recognition (NER), intensity, trend, veracity, tagging, and part-of-speech (POS) tagging. In some embodiments, natural language processing (NLP) is utilized for analyzing the social media feed in step (b). In some embodiments, the application further comprises: (d) a software module receiving one or more actions by an ESP user in relation to the relevant posts; and (e) a software module using the actions by the ESP user as feedback for improving the step of analyzing the social media feed in step (b). In some embodiments, the one or more actions by the ESP user comprises selecting the relevant posts for forwarding to one or more ESP users responding to the at least one current emergency situation. In some embodiments, the one or more actions by the ESP user comprises linking at least one of the relevant posts to one or more incident IDs of the at least one current emergency situation for CAD integration. In some embodiments, analyzing the social media feed in step (b) comprises supervised learning. In some embodiments, the one or more actions by the ESP user comprises selecting at least one of the relevant posts, wherein an I-frame is generated and displayed to one or more members of the ESP. In some embodiments, the I-frame is accessible on responder devices by emergency responders responding to the at least one current emergency situation. In some embodiments, the one or more actions by the ESP user comprises selecting relevant social media data and generating a new incident ID. In some embodiments, the new incident ID is associated with a mass casualty incident. In some embodiments, a social media analyst selects the relevant social media data for forwarding to at least one of a call taker, dispatcher, or responder who is responding to the at least one current emergency situation. In some embodiments, geo-bounding comprises analyzing at least one of check-in location, device-based location services, IP address, user selected location, or stored address. In some embodiments, analyzing the social media feed in (b) comprises natural language processing of the social media feed. In some embodiments, natural language processing (NLP) comprises parsing a filtered post. In some embodiments, natural language processing (NLP) comprises part-of-speech tagging words in a filtered post. In some embodiments, natural language processing (NLP) comprises performing text summarization on a filtered post. In some embodiments, filtering the social media feed in step (b)(ii) comprises geo-bounding the social media feed to a geo-bounded area corresponding to the geographical jurisdiction of the organization of the ESP user, wherein the ESP user is a member of a PSAP. In some embodiments, filtering the social media feed in step (b)(ii) comprises using one or more keywords selected from “shooter”, “fire”, “flood”, “gun”, “violence”, “help”, “911”, “112”, “999”, “000”, “emergency”, “protest”, “punch”, “assault”, “heart attack”, “medical”, “broken”, “explosion”, “trapped”, “sinking”, “hurt”, “pain”, “suffering”, “storm”, “lighting”, “gas”, “attack”, “poison”, “lost”, “fell”, “fallen”, “smashed”, “mangled”, “earthquake”, “tsunami”, “ambulance”, “police”, “EMT”, “failure”, “FEMA”, and “disaster.” In some embodiments, the filtering for geo-bounding in step (b)(i) using location data obtained from a social media network. In some embodiments, the social media data comprises one or more of keyword search results, relevant posts, trending news or topics, hashtag tracking, campaign tracking, shares, reach, engagement, mentions, sentiment analysis, user tagging, image recognition, face recognition, virality, and influencer tracking. In some embodiments, the social media data comprises metrics such as shares, likes, mentions, impression, hashtag usage, offensive language, URL clicks, keyword analysis, unique users, followers, new followers, and comments. In some embodiments, the social media data comprises analytics such as engagement, impressions, likes, post reach, reactions, unlikes, engagement rate, followers, link clicks, mentions, profile visits, retweets, replies, tweet impressions, and tweets. In some embodiments, the relevant posts comprise information associated with at least one current emergency comprising one or more of photos, video feed, audio, latitude-longitude coordinates, physical address, check-ins, chat messages, and status updates. In some embodiments, the application comprises: (a) a software module receiving an emergency data request from the ESP; and (b) a software module securely transmitting the emergency data associated with the emergency alert to the ESP in response to receiving the emergency data request, wherein the emergency data comprises relevant posts. In some embodiments, transmitting the relevant social media data comprising the relevant posts to an ESP further comprises: (a) the emergency data request comprises credentials associated with the ESP; and (b) verifying the credentials associated with the ESP before securely transmitting the emergency data, wherein the emergency data comprises relevant posts. In some embodiments, the application further comprises a software module detecting mass emergencies, wherein the relevant social media data identifies mass emergencies by one or more of trending topics or hashtags, social media content volume and key word sentiment severity. In some embodiments, the application further comprises a software module determining an affected area of the mass emergency by analyzing location of relevant posts.

Disclosed herein is an emergency assistance system (EAS) comprising a processor, a memory, and non-transitory computer readable medium including instructions executable by the processor to create a software application for producing relevant social media data for emergency response, the application comprising: (a) a software module accessing a social media feed comprising a plurality of posts published on a social media network by at least one user; (b) a software module analyzing the social media feed to identify the relevant social media data determined to be pertinent to at least one current emergency situation, wherein the relevant social media data comprises one or more relevant posts from the plurality of posts; (c) a software module associating the relevant posts to an incident that corresponds to the at least one current emergency situation and is tracked using computer aided dispatch (CAD); and (d) a software module providing the relevant posts to an emergency service provider (ESP) user via a browser window. In some embodiments, the browser window is a full window or a mini window. In some embodiments, the mini window is an I-frame, AJAX, or HTML5. In some embodiments, the I-frame is accessible on one or more responder devices by one or more emergency responders responding to the at least one current emergency situation. In some embodiments, the system comprises a software module determining an affected area of the incident by analyzing location of relevant posts, wherein the incident is a new CAD incident ID that is associated with a mass casualty incident. In some embodiments, the incident is an existing incident tracked using CAD, and associating the relevant posts to the incident comprises linking the relevant posts to the existing incident. In some embodiments, associating the relevant posts to an incident comprises generating a new incident for CAD. In some embodiments, analyzing the social media feed to identify relevant social media data comprises processing the social media feed using a machine learning algorithm trained with supervised learning. In some embodiments, the relevant social media data is selected by a social media analyst for forwarding to at least one of a call taker, dispatcher, or responder who is responding to the at least one current emergency situation. In some embodiments, the relevant posts comprise information associated with at least one current emergency comprising one or more of photo, video feed, audio, latitude-longitude coordinates, physical address, check-ins, chat message, or status update. In some embodiments, the system further comprises: (a) a software module receiving an emergency data request from the ESP; and (b) a software module securely transmitting emergency data associated with the incident to the ESP in response to receiving the emergency data request, wherein the emergency data comprises the relevant posts. In some embodiments, the emergency data further comprises sensor data, location data, medical or health data, or any combination thereof In some embodiments: (a) the emergency data request comprises credentials associated with the ESP, and (b) transmitting the relevant social media data to an ESP further comprises verifying the credentials associated with the ESP before securely transmitting the emergency data. In some embodiments, the software module analyzing the social media data in (b) performs steps comprising: (i) filtering the social media feed using geo-bounding and keywords to generate a filtered feed comprising filtered posts; and (ii) processing the filtered feed to produce the relevant social media data by analyzing the filtered posts to identify relevant posts based on one or more of bots, emotion, categorization, location, named entity recognition (NER), intensity, trend, veracity, tagging, and part-of-speech (POS) tagging. In some embodiments, geo-bounding comprises analyzing at least one of check-in location, device-based location services, IP address, user selected location, or stored address. In some embodiments, analyzing the social media data comprises natural language processing (NLP) by performing text summarization on a filtered post. In some embodiments, filtering the social media feed in (b) (ii) comprises geo-bounding the social media feed to a geo-bounded area corresponding to the geographical jurisdiction of the organization of the ESP user, wherein the ESP user is a member of a PSAP.

Disclosed herein is a computer-implemented method for producing relevant social media data for emergency response, comprising: (a) accessing a social media feed comprising a plurality of posts published on a social media network by at least one user; (b) analyzing the social media feed to identify the relevant social media data determined to be pertinent to at least one current emergency situation, wherein the relevant social media data comprises one or more relevant posts from the plurality of posts; (c) associating the relevant posts to an incident that corresponds to the at least one current emergency situation and is tracked using computer aided dispatch (CAD); and (d) providing the relevant posts to an emergency service provider (ESP) user via a browser window. In some embodiments, the browser window is a full window or a mini window. In some embodiments, the mini window is an I-frame, AJAX, or HTML5. In some embodiments, the I-frame is accessible on one or more responder devices by one or more emergency responders responding to the at least one current emergency situation. In some embodiments, the method further comprises determining an affected area of the incident by analyzing location of relevant posts, wherein the incident is a new CAD incident ID that is associated with a mass casualty incident. In some embodiments, the incident is an existing incident tracked using CAD, and associating the relevant posts to the incident comprises linking the relevant posts to the existing incident. In some embodiments, associating the relevant posts to an incident comprises generating a new incident for CAD. In some embodiments, analyzing the social media feed to identify relevant social media data comprises processing the social media feed using a machine learning algorithm trained with supervised learning. In some embodiments, the relevant social media data is selected by a social media analyst for forwarding to at least one of a call taker, dispatcher, or responder who is responding to the at least one current emergency situation. In some embodiments, the relevant posts comprise information associated with at least one current emergency comprising one or more of photo, video feed, audio, latitude-longitude coordinates, physical address, check-ins, chat message, or status update. In some embodiments, the method further comprises: (a) receiving an emergency data request from the ESP; and (b) securely transmitting emergency data associated with the incident to the ESP in response to receiving the emergency data request, wherein the emergency data comprises the relevant posts. In some embodiments, the emergency data further comprises sensor data, location data, medical or health data, or any combination thereof. In some embodiments: (a) the emergency data request comprises credentials associated with the ESP, and (b) transmitting the relevant social media data to an ESP further comprises verifying the credentials associated with the ESP before securely transmitting the emergency data. In some embodiments, analyzing the social media data in (b) comprises: (i) filtering the social media feed using geo-bounding and keywords to generate a filtered feed comprising filtered posts; and (ii) processing the filtered feed to produce the relevant social media data by analyzing the filtered posts to identify relevant posts based on one or more of bots, emotion, categorization, location, named entity recognition (NER), intensity, trend, veracity, tagging, and part-of-speech (POS) tagging. In some embodiments, geo-bounding comprises analyzing at least one of check-in location, device-based location services, IP address, user selected location, or stored address. In some embodiments, analyzing the social media data comprises natural language processing (NLP) by performing text summarization on a filtered post. In some embodiments, filtering the social media feed in (b) (ii) comprises geo-bounding the social media feed to a geo-bounded area corresponding to the geographical jurisdiction of the organization of the ESP user, wherein the ESP user is a member of a PSAP.

Disclosed herein is non-transitory computer readable medium including instructions executable by a processor to create a software application for producing relevant social media data for emergency response, the application comprising: (a) a software module accessing a social media feed comprising a plurality of posts published on a social media network by at least one user; (b) a software module analyzing the social media feed to identify the relevant social media data determined to be pertinent to at least one current emergency situation, wherein the relevant social media data comprises one or more relevant posts from the plurality of posts; (c) a software module associating the relevant posts to an incident that corresponds to the at least one current emergency situation and is tracked using computer aided dispatch (CAD); and (d) a software module providing the relevant posts to an emergency service provider (ESP) user via a browser window. In some embodiments, the browser window is a full window or a mini window. In some embodiments, the mini window is an I-frame, AJAX, or HTML5. In some embodiments, the I-frame is accessible on one or more responder devices by one or more emergency responders responding to the at least one current emergency situation. In some embodiments, the application comprises a software module determining an affected area of the incident by analyzing location of relevant posts, wherein the incident is a new CAD incident ID that is associated with a mass casualty incident. In some embodiments, the incident is an existing incident tracked using CAD, and associating the relevant posts to the incident comprises linking the relevant posts to the existing incident. In some embodiments, associating the relevant posts to an incident comprises generating a new incident for CAD. In some embodiments, analyzing the social media feed to identify relevant social media data comprises processing the social media feed using a machine learning algorithm trained with supervised learning. In some embodiments, the relevant social media data is selected by a social media analyst for forwarding to at least one of a call taker, dispatcher, or responder who is responding to the at least one current emergency situation. In some embodiments, the relevant posts comprise information associated with at least one current emergency comprising one or more of photo, video feed, audio, latitude-longitude coordinates, physical address, check-ins, chat message, or status update. In some embodiments, the application further comprises: (a) a software module receiving an emergency data request from the ESP; and (b) a software module securely transmitting emergency data associated with the incident to the ESP in response to receiving the emergency data request, wherein the emergency data comprises the relevant posts. In some embodiments, the emergency data further comprises sensor data, location data, medical or health data, or any combination thereof In some embodiments: (a) the emergency data request comprises credentials associated with the ESP, and (b) transmitting the relevant social media data to an ESP further comprises verifying the credentials associated with the ESP before securely transmitting the emergency data. In some embodiments, the software module analyzing the social media data in (b) performs steps comprising: (i) filtering the social media feed using geo-bounding and keywords to generate a filtered feed comprising filtered posts; and (ii) processing the filtered feed to produce the relevant social media data by analyzing the filtered posts to identify relevant posts based on one or more of bots, emotion, categorization, location, named entity recognition (NER), intensity, trend, veracity, tagging, and part-of-speech (POS) tagging. In some embodiments, geo-bounding comprises analyzing at least one of check-in location, device-based location services, IP address, user selected location, or stored address. In some embodiments, analyzing the social media data comprises natural language processing (NLP) by performing text summarization on a filtered post. In some embodiments, filtering the social media feed in (b) (ii) comprises geo-bounding the social media feed to a geo-bounded area corresponding to the geographical jurisdiction of the organization of the ESP user, wherein the ESP user is a member of a PSAP.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate various non-limiting embodiments of the present disclosure and, together with the description, serve to explain the principles of the present disclosure. The diagrams are for illustration only, which thus is not a limitation of the present disclosure, and wherein:

FIGS. 1A, 1B, 1C, and 1D illustrate components of the emergency assistance system (EAS), communication devices, and PSAP systems in accordance with an embodiment of the present disclosure.

FIG. 2 illustrates one embodiment of the emergency assistance system (EAS) for analyzing social media content for emergency response.

FIG. 3 illustrates an implementation of the proposed emergency assistance system (EAS), in accordance with an embodiment of the present disclosure.

FIG. 4 illustrates an embodiment of the flow used by the emergency assistance system (EAS) to link relevant social media data with a current emergency and sending the data to a call taker in accordance with an embodiment of the present disclosure.

FIG. 5 illustrates an EAS, in accordance with an embodiment of the present disclosure.

FIG. 6 illustrates screens for a public safety answering point (PSAP), in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

The present disclosure relates generally to public safety, and in some embodiments, relates to managing, distributing, and validating emergency alert messages via social media. In some embodiments, the Emergency Alert System (“EAS”) analyzes social media feeds for relevant information regarding emergency alerts or requests for emergency assistance (e.g., fire, medical, flooding, earthquake, etc.). In some embodiments, the EAS is configured for receiving human input for identifying relevant social media data comprising one or more relevant posts. In some embodiments, an ESP (e.g., a PSAP) has one or more users or workers who provide input to the EAS for selecting relevant social media data. In some embodiments, the ESP user (e.g., a call taker, dispatcher, supervisor, manager, social media analyst, a communication specialist, or other) links the relevant social media data to one or more unique IDs for current or on-going emergencies. In some embodiments, with software integration through CAD, the relevant social media data is visible to one or more users down the line (e.g., the dispatcher, emergency responders, supervisors). In some embodiments, the input from the ESP user is used to improve the analysis of the social media feed.

It is contemplated that the EAS is able to identify a mass emergency or a mass casualty incident (MCI) that is occurring in a specific area. In some embodiments, the EAS is configured to send warning messages pertaining to weather conditions, disasters, AMBER (America's Missing: Broadcast Emergency Response) alerts, and/or alerts issued by the Government to subscribers in the area.

In some embodiments, the EAS is used for sending a request for emergency assistance to an appropriate emergency service provider (e.g., a PSAP), especially when there is no incident ID (or other unique ID) has not been assigned to the current emergency. In some cases, the appropriate PSAP is determined based on the location of the emergency. In some embodiments, the location of the emergency, the type and/or severity of the emergency, or any combination thereof are used to determine the appropriate ESP for sending the emergency. Accordingly, some embodiments of the EAD are configured for early detection of emergencies using social media data.

In some embodiments, user-generated social media posts containing an emergency indication are detected as relevant posts, as a part of relevant social media data. In some embodiments, the ESP user makes a determination that the emergency situation is not being addressed (e.g., no unique emergency ID found for the emergency), and a new emergency alert (via a new unique emergency ID) is optionally generated. In some embodiments, one or more unique emergency IDs (e.g., incident IDs) related to a mass emergency are linked together and with the relevant social media data. In some embodiments, the emergency IDs and relevant social media data are linked together in a database of the EAS. In some embodiments, one or more bystander users (person who witnesses or knows about another person in danger) requests emergency assistance on behalf of the person in the emergency, optionally via social media.

In some embodiments, an emergency management system (EMS) includes a clearinghouse (also referred to as an “Emergency Clearinghouse”) that functions to receive enhanced locations and additional data from various sources including social media data and at various times before, during, or after emergency situations and distribute enhanced locations and additional data to ESPs to aid the ESPs in responding to on-going emergency situations. In some embodiments, the enhanced locations and additional data are delivered by the EMS to the ESP at a public safety answering point (PSAP). In some embodiments, the enhanced locations and additional data are displayed within a pre-existing ESP system, such as an Automatic Location Identification (ALI) display. In some embodiments, the enhanced locations and additional data including social media data are displayed through a window (also referred to as an “Enhanced Data Window”) within a desktop application installed at the ESP.

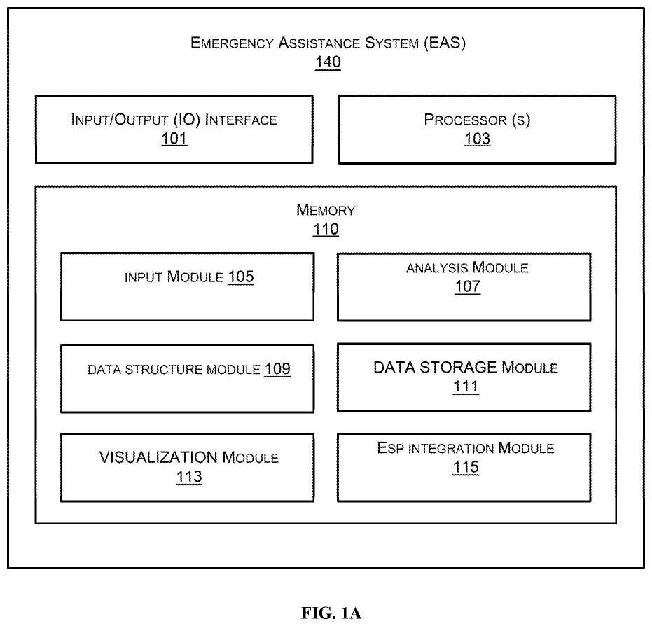

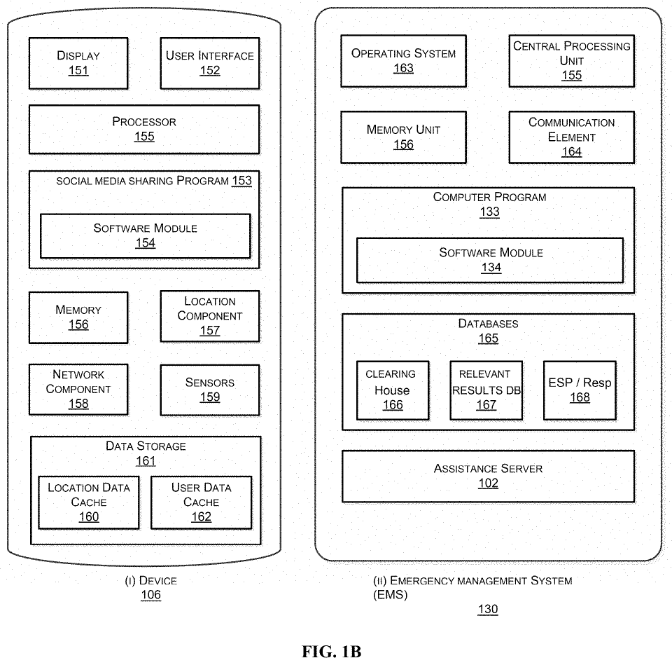

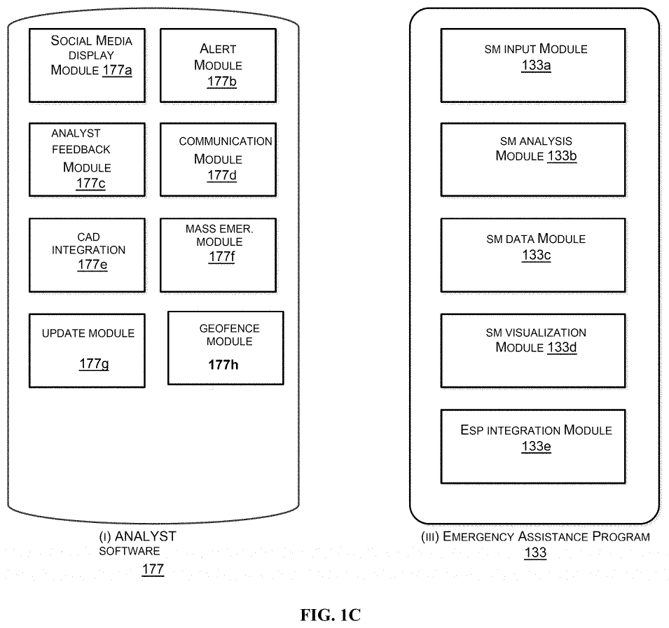

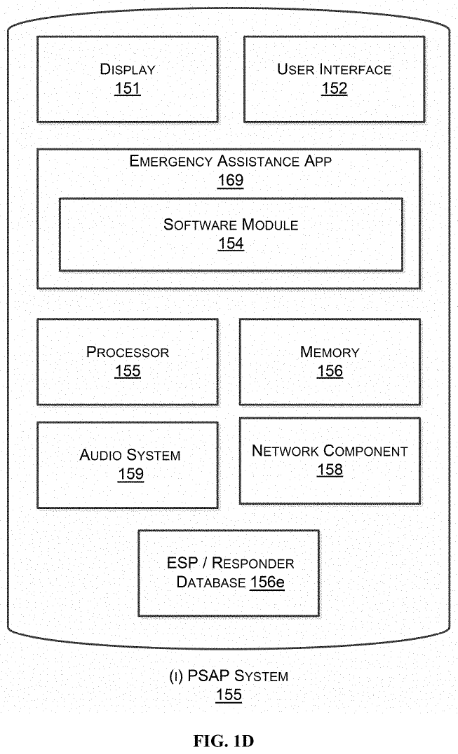

FIG. 1A illustrates embodiments of functional modules of the proposed emergency assistance system (EAS) 140, in accordance with an embodiment of the present disclosure. In one embodiment, the proposed emergency assistance system (EAS) 140 comprises at least one of an input/output (I/O) interface 101, processor(s) 103, and a memory 110.

In some embodiments, the I/O interface 101 includes a variety of software and hardware interfaces, for example, a web interface, a graphical user interface, an analog user interface, or other suitable interface. In some embodiments, the I/O interface 101 allows the proposed emergency assistance system (EAS) 140 to interact with a user (e.g., an ESP user) directly or through the client devices, such as device 106. Further, in some embodiments, the I/O interface 101 enables the proposed emergency assistance system (EAS) 140 to communicate with other computing devices, such as web servers and external data servers (not shown). In some embodiments, the I/O interface 101 facilitates multiple communications within a wide variety of networks and protocol types, including wired networks, for example, LAN, cable, etc., and wireless networks, such as WLAN, cellular, or satellite. In some embodiments, the I/O interface 101 includes one or more ports for connecting a number of devices to one another or to another server.

In some embodiments, the at least one processor 103 is implemented as one or more microprocessors, microcomputers, microcontrollers, digital signal processors, central processing units, state machines, logic circuitries, and/or any devices that manipulate signals based on operational instructions. Among other capabilities, the at least one processor 103 is configured to fetch and execute computer-readable instructions stored in the memory 110.

In some embodiments, the memory 110 includes any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. In some embodiments, the memory 110 comprises modules, routines, programs, objects, components, data2 structures, etc., which perform particular tasks or implement particular abstract data types. In one implementation, the memory 110 includes an input module 105 (for inputting social media feed), an analysis module 107 (for analyzing social media feed(s) to identify relevant social media data), a data structure module 109 (providing a logical structure to the data), a data storage module 111 (storing the data in a database), a visualization module 113 (displaying data analytics and relevant posts and allowing ESP user action), an ESP integration module 115 (e.g., for integration into CAD), or any combination thereof.

In some embodiments, the proposed emergency assistance system (EAS) 140 for sending a request for emergency assistance comprises at least one processor 103, an operating system configured to perform executable instructions, a memory 110 unit, and a computer program including instructions executable by the at least one processor 103 to create an application. The computer program can include the social media feed module 105 to access a social media feed (e.g., from Twitter, Facebook, Instagram, Snapchat, Reddit, or other social media network), wherein the social media feed includes a plurality of posts published in a social media network by users, the analysis module 107 to identify the relevant social media data determined to be pertinent to at least one current emergency situations, the data structure module 109 & data storage module 111 to store the data in searchable form, and the visualization module 113 and the ESP integration module 115 to display the relevant social media data comprising the relevant posts to an emergency service provider (ESP) user. In some embodiments, an ESP is an emergency dispatch center (EDC) such as a public safety answering point (PSAP), or other emergency service providers such as police departments, fire departments, medical facilities, and emergency responders.

FIG. 1B illustrates components of a communication device 106 and the Emergency Management System (EMS) 130 in accordance with an embodiment of the present disclosure. In some embodiments, the communication device is an access device that can be used by a user to post on social media platforms. In some cases, the device 106 is a triggering device that is triggering an emergency alert by, e.g., making a call to 911. In one embodiment, the device 106 comprises an input/output (I/O) interface 152, processor(s) 155, and a memory 156. In some embodiments, the device 106 comprises a display 151.

In some embodiments, the I/O interface 152 comprises one or more software and/or hardware interfaces, for example, a web interface, a graphical user interface, and the like. In some embodiments, the I/O interface 152 allows the proposed device 106 to interact with a user directly or through any mobile application installed in the device 106. Further, the I/O interface 152 may enable the proposed access device 106 to communicate with other computing devices, such as web servers and external data servers (not shown). In some embodiments, the I/O interface 152 facilitates multiple communications within a wide variety of networks and protocol types, including wired networks, for example, LAN, cable, and wireless networks, such as WLAN, cellular, or satellite. In some embodiments, the I/O interface 152 comprises one or more ports for connecting a number of devices to one another or to another server.

In some embodiments, the at least one processor 155 is implemented as one or more microprocessors, microcomputers, microcontrollers, digital signal processors, central processing units, state machines, logic circuitries, and/or any devices that manipulate signals based on operational instructions. Among other capabilities, the at least one processor 155 is configured to fetch and execute computer-readable instructions stored in the memory 156.

In some embodiments, the memory 156 comprises a computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. In some embodiments, the memory 156 comprises at least one of modules, routines, programs, objects, components, data structures, which perform particular tasks or implement particular abstract data types. In one implementation, the memory 156 comprises a social media sharing program 153 with one or more software modules 154.

In some embodiments, a device 106 comprises at least one processor 155, a memory 156, a network component 158, and a computer program 153 including instructions executable by the at least one processor to create a social media sharing application. The computer program can include one or more software modules 154 such as a social media module creating one or more social media posts with an indication of emergency (e.g., school shooting, call 911), a location detection module configured to obtain current location data associated with the one or more persons requiring the emergency assistance from the information retrieved, and an emergency communication module configured to transmit an emergency alert comprising a data set associated with the emergency and the current location data to an emergency assistance system (EAS) for transmission to one or more appropriate recipients for providing emergency assistance.

In some embodiments, the emergency communication module transmits device-based location data (e.g., GPS, location services-based location, etc.), sensor data (e.g., user heart-rate data) periodically with the EAS (or through the EMS). In some embodiments, the device 106 includes one or more sensors such as a camera, a microphone, etc. Using device 106, a user can share image files, video files (including live feed), text files, audio files, etc. from a microphone or camera on the device 106.

FIG. 1B also shows a schematic diagram of one embodiment of an emergency management system 130 as described herein. In some embodiments, the emergency management system 130 comprises one or more of an operating system 163, at least one central processing unit or processor 155, a memory unit 156, a communication element 164, and a computer program 133 (e.g., server application or emergency assistance system or program) comprising at least one software module 134. In some embodiments, the emergency assistance system 140 comprises one or more databases 165 for storing emergency data such as the emergency registry. In some embodiments, the emergency assistance system 140, which can be part of the EMS 130, comprises an emergency clearinghouse 166 including a location database 166a (not shown), an additional information database 166b (not shown), a relevant results database 167, and an ESP and Responder database 168, or any combination thereof.

In some embodiments, the clearinghouse 166, as described in further detail below, is an input/output (I/O) interface configured to manage communications and data transfers to and from the EMS 130 and external systems and devices. In some embodiments, the clearinghouse 166 includes a variety of software and hardware interfaces, for example, a web interface, a graphical user interface (GUI), and the like. The clearinghouse 166 optionally enables the EMS 130 to communicate with other computing devices, such as web servers and external data servers (not shown). In some embodiments, the clearinghouse 166 facilitates multiple communications within a wide variety of networks and protocol types, including wired networks, for example, LAN, cable, etc., and wireless networks, such as WLAN, cellular, or satellite. In some embodiments, the clearinghouse 166 includes one or more ports for connecting a number of devices to one another or to another server. In some embodiments, the clearinghouse 166 includes one or more sub-clearinghouses, such as location clearinghouse 166a and additional data clearinghouse 166b, configured to manage the transfer of locations and additional data (not shown).

FIG. 1C shows a schematic diagram of one embodiment of a software application 177 installed on an analyst device 176 (not shown). In some embodiments, the software application 177 comprises one or more device software modules such as a social media display module 177a (for displaying social media analytics and relevant posts), an alert module 177b (for generating new alerts such as a new incident ID for new emergencies), an analyst feedback module 177c (allowing analyst to provide feedback to the analysis algorithm for improving results), a communication module 177d (allowing follow-up communication between the analyst and ESP members regarding the relevant social media data), a CAD integration module 177e (for integrating relevant social media data and relevant posts to be integrated into CAD screens), a mass emergency module 177f (for identifying relevant posts regarding a mass emergency and identifying the specific area of the mass emergency), an update module 177g (for providing an updated relevant social media data including new trends and updated posts), a geofence module 177h (for storing and retrieval of geofences associated with ESPs) or any combination thereof.

Emergency Data Geofencing

In some embodiments, a geofence is applied to a clearinghouse for emergency data. In some embodiments, a geofence module 177h is applied to the clearinghouse 166 to protect potentially sensitive emergency data using geospatial analysis. In some embodiments, the clearinghouse 166 includes a set of ingestion and retrieval modules (not shown). The set of ingestion modules can receive emergency data, or other information that can be useful in responding to an emergency, from a variety of sources. For example, in some embodiments, a smartphone sends emergency data to the clearinghouse 166 in the form of an HTTP POST API call in response to a user of the smartphone initiating a 911 emergency call.

In some embodiments, when emergency data (e.g., an emergency location or additional emergency data) is sent from an electronic device to the clearinghouse 166, the emergency data is first processed by a geofence module 177h before being received by the set of ingestion modules within the clearinghouse 166. Similarly, in some embodiments, when an emergency data request is sent from a requesting party (e.g., the emergency response application), the emergency data request is processed by the geofence module 177h before being received by the set of retrieval modules for display on a GUI of the emergency response application on a computing device of the requesting party.

In some embodiments, as mentioned above, a geofence module 177h is applied to the clearinghouse 166 to protect potentially sensitive emergency data using geofences. Generally, a geofence is a virtual perimeter for a real-world geographic area. A geofence can be dynamically generated—as in a radius around a point location—or a geofence can be a predefined set of boundaries (such as school zones or neighborhood boundaries). The use of a geofence is called geofencing, and one example of usage involves a location-aware device of a location-based service (LBS) user entering or exiting a geofence. Entry or exit from a geofence could trigger an alert to the device's user as well as messaging to the geofence operator. The geofence information, which could contain the location of the device, could be sent to a mobile telephone or an email account.

For emergency response, an emergency service provider (public or private entities) may be given jurisdictional authority to a certain geographical region or jurisdiction (also referred to as “authoritative regions”). In the context of emergency services, one or more geofences may correspond to the authoritative region of an ESP. In many cases, the ESP is a public entity such as a public safety answering point (PSAP) or a public safety service (PSS; e.g., a police department, a fire department, a federal disaster management agency, national highway police, etc.), which have jurisdiction over a designated area (sometimes, overlapping areas). Geofences are used to define the jurisdictional authority by various methods and in various Geographic Information System (GIS) formats. In some embodiments, geofences only represent authoritative regions if the geofence has been assigned or verified by a local, state, or federal government. In some embodiments, geofences represent assigned jurisdictions that are not necessarily authoritative regions. For example, in some embodiments, a geofence is unilaterally created by its associated ESP without verification or assignment by a local, state, or federal government.

Geofences can be defined in various ways. For example, in some embodiments, a geofence comprises one or more of the following: a county boundary, a state boundary, a collection of postal/zip codes, a collection of cell sectors, simple shapes, complex polygons, or other shapes or areas. In some embodiments, geofences comprise approximations where the “approximated” geofence encloses an approximation of the authoritative region.

Updates to geofences may be required over time because the authoritative regions may change over time. Geofences may change over time (e.g., a new sub-division has cropped up) and require updates. In some embodiments, the systems and methods described herein allow geofences to be updated (e.g., a PSAP administrator can upload updated geofence GIS shapefiles).

For maintaining the privacy, security and integrity of the data, geofencing may be applied to emergency data. For example, applying geofence filters to the emergency data allows additional avenues for monitoring, both visibility and control, over the clearinghouse to detect anomalies/spikes and reduce the risk of security breaches.

FIG. 1C also shows a schematic diagram of one embodiment of an emergency assistance program 133 installed on a server (e.g., a server in an EMS). In some embodiments, the server application comprises one or more emergency assistance software modules such as a SM input module 133a, a SM analysis module 133b, a SM data module 133c, a visualization module 133d, an ESP integration module 133e, or any combination thereof.

FIG. 1D shows a schematic diagram of one embodiment of an ESP, e.g., a Public Safety Answering Point (PSAP) system 155 as described herein. In some embodiments, the PSAP system 155 comprises one or more of display 151, a user interface 152, at least one central processing unit or processor 155, a memory unit 156, a network component 158, an audio system 159 (e.g., microphone, speaker and/or a call-taking headset or other sensor) and a computer program such as a PSAP Emergency Assistance Application 169. In some embodiments, the PSAP application 156 comprises one or more software modules 154. In some embodiments, the PSAP system 150 comprises a display module, a feedback module, an update module, a mass emergency module, and a database of ESPs and responders 156e (e.g., medical assets, police assets, fire response assets, rescue assets, safety assets).

The emergency assistance application 169 installed on a PSAP system 155 (e.g., a server in the PSAP system). In some embodiments, the PSAP emergency assistance application 169 comprises one or more emergency assistance software modules. In some embodiments, a software module is a call-taking display module (for handling emergency calls), a mapping module (for viewing location of the emergency on a map), an emergency search module (for providing key words for searching social media feed), an update module (for obtaining updated social media data), a response status module (for marking the status of the response), or any combination thereof

It is contemplated that a responder device such as a radio, a walkie talkie, a vehicle unit, etc. may have components similar to the device as shown in FIG. 1B such as display, user interface, processor, memory, location component, network component, data storage, emergency assistance application including software modules. In some embodiments, the application on the responder devices has similar functionality to the application 169. In particular, the device may have a mapping module, an emergency search module, an update module, a response status module or any combination thereof.

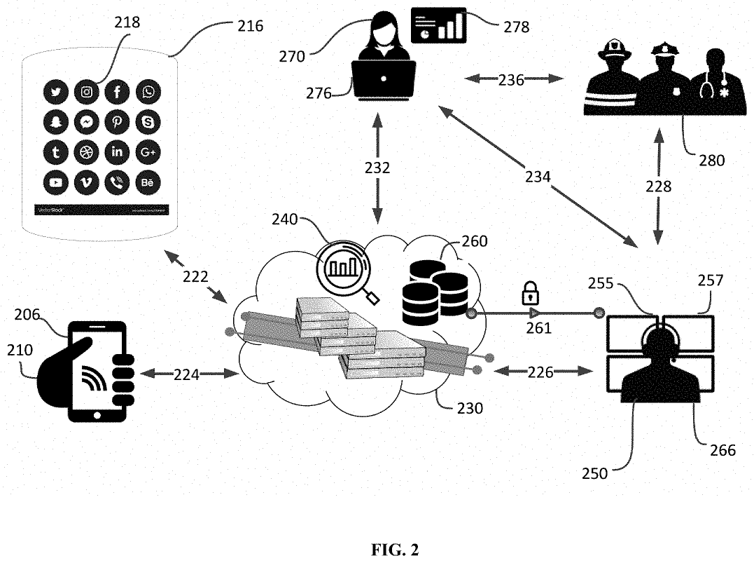

FIG. 2 illustrates an embodiment of proxy alert where a user 220 (not shown) of an access device 216, sends an emergency alert on behalf of a person 210 in an emergency (e.g., a building on fire). User 210 of access device 216 (e.g., a mobile wireless phone) initiates the process by generating a social media post on a social media network 218 with an emergency indication (e.g., “Turner Tower on fire! Residents in danger. Please help!”) on behalf of the user in the emergency 210. The EAS 240 may display user's 220 social media post as relevant to a current emergency and display for an ESP user (e.g., a social media analyst 270). The social media analyst 270 may generate an emergency alert by assigning a unique emergency ID after determining that this is a new emergency and has not been previously reported. In some embodiments, the user 210 have authorized the second user 220 to share his or her location in case of an emergency. In some embodiments, user 210, 220 are in a group of family and/or friends who have joined their devices to a group of devices and authorized sharing their location data with each other (location services data from 206 may be sent to device 216 for sending the emergency alert). In some embodiments, the location of the person 210 is obtained based on information in various sources, e.g., location data (Turner Tower) included in the relevant social media post. The location of the emergency is used to determine the appropriate ESP (e.g., PSAP) for sending the emergency alert.

FIG. 2 illustrates a network implementation of a proposed emergency assistance system (EAS), in accordance with an embodiment of the present disclosure. It would be appreciated that aspects of the present disclosure can be applied to a variety of network architectures, all of which are well within the scope of the present disclosure.

In some embodiments, a user 220 communicates with the network using an access device 216 that optionally includes a human-to-machine interface with network connection capability that allows access to a network. For example, the access device may include a stand-alone interface (e.g., a cellular telephone, a smartphone, a home computer, a laptop computer, a tablet, a personal digital assistant (PDA), a computing device, a wearable device such as a smart watch, a wall panel, a keypad, or the like), an interface that is built into an appliance or other device e.g., a television, a refrigerator, a security system, a game console, a browser, or the like), a speech or gesture interface (e.g., a Kinect™ sensor, a Wiimote™, or the like), an IoT device interface (e.g., an Internet enabled device such as a wall switch, a control interface, or other suitable interface), or the like. In some embodiments, the access device may include a cellular or other broadband network transceiver radio or interface, and may be configured to communicate with a cellular or other broadband network using the cellular or broadband network transceiver radio. In some embodiments, the access device 216 may not include a cellular network transceiver radio or interface. User 220 may interact with the network using an application, a web browser, a proprietary program, or any other program executed and operated by the access device.

Non-limiting examples of local area networks include a wireless network, a wired network, or a combination of a wired and wireless network. In some embodiments, a wireless network includes any wireless interface or combination of wireless interfaces (e.g., Zigbee™, Bluetooth™, WiFi™, IR, UWB, WiFi-Direct, BLE, cellular, Long-Term Evolution (LTE), WiMax™, or the like). In some embodiments, a wired network includes any wired interface (e.g., fiber, Ethernet, powerline, Ethernet over coaxial cable, digital signal line (DSL), or the like). The wired and/or wireless networks can be implemented using various routers, access points, bridges, gateways, or the like, to connect devices in the local area network. For example, in some cases, the local area network includes at least one gateway. In some embodiments, a gateway provides communication capabilities to network devices and/or access device via radio signals in order to provide communication, location, and/or other services to the devices. In some embodiments, the gateway is directly connected to the external network and provides other gateways and devices in the local area network with access to the external network. In some cases, the gateway is designated as a primary gateway.

The network access provided by a gateway may be of any type of network familiar to those skilled in the art that can support data communications using any of a variety of commercially-available protocols. For example, gateways may provide wireless communication capabilities for the local area network using particular communications protocols, such as WiFi™ (e.g., IEEE 802.11 family standards, or other wireless communication technologies, or any combination thereof). Gateways may include a router, a modem, a range extending device, and/or any other device that provides network access among one or more computing devices and/or external networks. For example, gateway may include a router or access point or a range extending device. Examples of range extending devices may include a wireless range extender, a wireless repeater, or the like.

FIG. 2 illustrates one embodiment of the emergency assistance system (EAS) 240 for analyzing social media content for emergency response. Although the emergency assistance system (EAS) 240 is depicted as an application in the emergency management system 230, it is understood that the EAS 240 may also be implemented in a variety of computing systems, such as a laptop computer, a desktop computer, a notebook, a workstation, a server, a network server, a cloud-based environment and the like.

In some embodiments, the EAS 240 is accessed by a user 220 (alternatively, several users 220-1, 220-2 . . . 220-N), through a communication device 216 using a social media application 218 providing access to one or more social media networks (via an application installed on device 216). User 220 is able to post content on the social media network via a network component (not shown) such as a wireless card for accessing the Internet (not shown).

For example, user 216 is a bystander who observes a building on fire and notices residents inside the building (e.g., user 210), who need emergency assistance as shown in FIG. 2. User 220 posts a message about the emergency on a social media network (such as but not limited to Facebook, Twitter, Google Plus, YouTube, Spoke, NextDoor, Snap, LinkedIn, etc.) on the Internet.

In the social media post, the user 220 may share keywords with or without the hashtags, where the keyword is indicative of an emergency. The keywords may be selected from any or combination of “shooter”, “fire”, “flood”, “gun”, “violence”, “help”, “911”, “112”, “999”, “000”, “emergency”, “protest”, “punch”, “assault”, “heart attack”, “medical”, “broken”, “explosion”, “trapped”, “sinking”, “hurt”, “pain”, “suffering”, “storm”, “lighting”, “gas”, “attack”, “poison”, “lost”, “fell”, “fallen”, “smashed”, “mangled”, “earthquake”, “tsunami”, “ambulance”, “police”, “EMT”, “failure”, “FEMA”, “shooting” and “disaster”. For example, the user 308-2 may have posted a message: “Saw a building on fire on 29^{th} Street. Emergency! #911.” The EAS 240 may access social media feed via the Internet depicted by communication link 222.

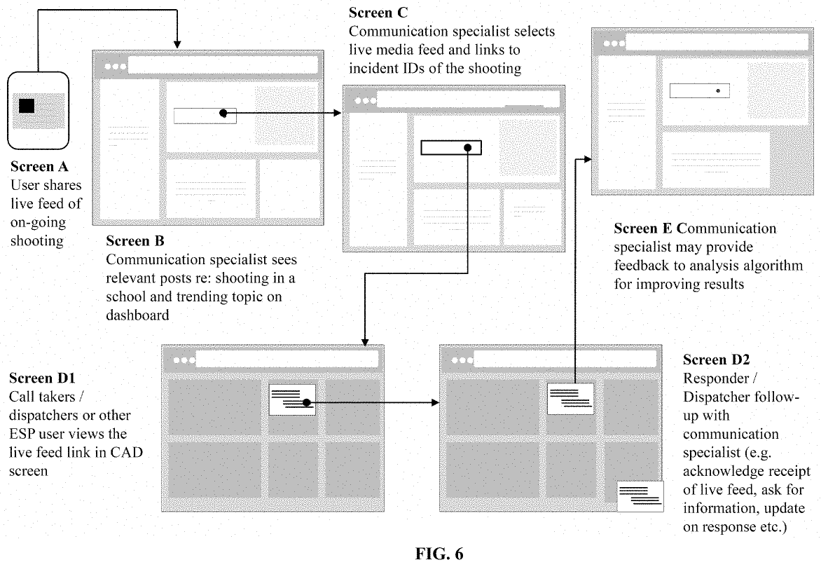

In some embodiments, user 220 includes or updates the social media post by sharing images, audio files, live video feed from the emergency. For example, user 220 may post an image or video of the building on fire (to identify the building, the severity and extent of the fire, residents in the building, the preferred approach to the building, etc.). In some embodiments, the EAS 240 analyzes the image or video and provides it in the relevant social media data for ESP users (see screens B, D1, D2 in FIG. 6) including emergency responders. It is contemplated that although users are posting on social media networks, they may not be able to directly request emergency assistance for user 210 in the building (e.g., phone lines are busy, appropriate PSAP is not known, no cellular connection, etc.).

Once the information about the emergency (fire in the building) is made available to an ESP user (e.g., a social media analyst, a call taker, etc.), it is optionally associated with a current or on-going emergency to provide situational awareness regarding the emergency. For example, the user 210 has called for emergency help using a communication device 206 and is on the line with a call taker 266 at an ESP (e.g., a PSAP 250) for getting help. The user 210 may provide the location of the building and description of the fire (but, she may not be able to tell the extent, severity or cause of the fire). The device-based hybrid location from the device 206 may also be available to the call taker through various technologies. Although not depicted, it is contemplated that users in the building have also called the PSAP 250 regarding the emergency (associated with one or more unique emergency IDs).

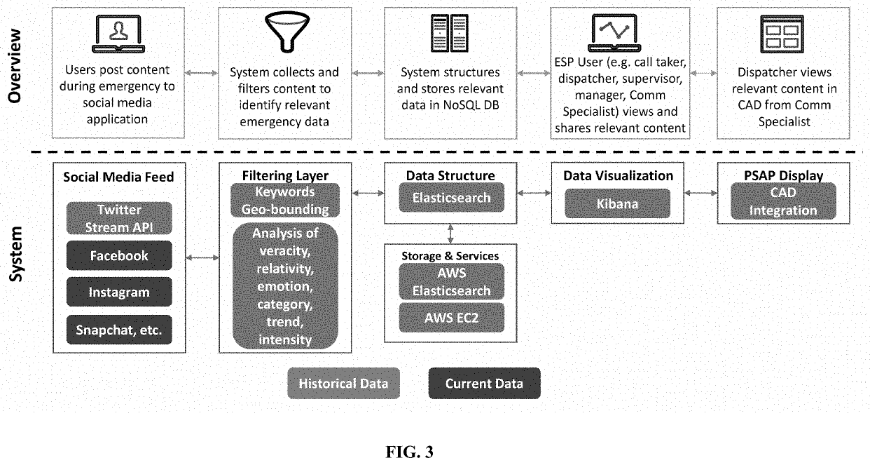

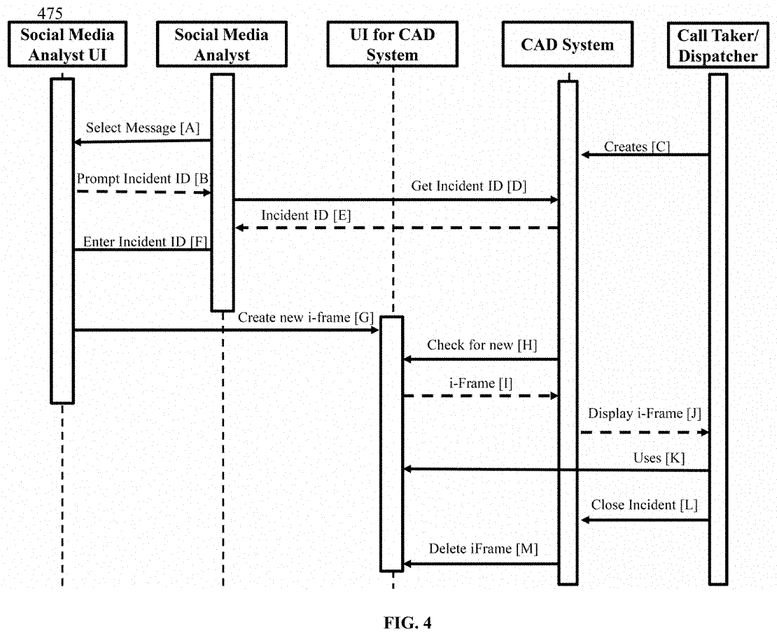

In some embodiments, a social media analyst 270 acts as a conduit or screen for the relevant social media data obtained by the EAS 240. In some embodiments, the analyst 270 on device 276 (software program 277, not shown) on display 278 accesses the EAS 240 results via a link 232. In some embodiments, the analyst provides relevant social media data to other ESP users such as call takers 266 and emergency responders 280 as described in FIGS. 3, 4, & 5.

In some embodiments, the ESP (e.g., PSAP 250) includes an ESP user (e.g., call taker 266) accessing the PSAP system 255 (see FIG. 1D). In some embodiments, the PSAP system includes a display 151, which may display screens such as screens D1, D2 in FIG. 6 including relevant social media data identified by the EAS 240.

In some embodiments, the EMS 230 connects the user 210 to the PSAP 250 after determining the appropriate emergency service providers (ESPs) for responding to the emergency. In some embodiments, the location, type and severity of the emergency may determine the appropriate ESP. In some embodiments, the ESPs includes private or public emergency dispatch centers (EDCs), such as PSAP 250 and emergency responders 280 for providing the emergency assistance. In some embodiments, the EMS 230 receives and transmits a request for the emergency assistance comprising the location associated with the emergency via links 224 & 226. In an example, the EMS 230 sends an alert to PSAP 250 or responders 280 on their mobile device (not shown). In some embodiments, EMS 230 sets up an emergency call or emergency session between the user device 206 and PSAP 250. In some embodiments, the EMS 230 functions as a bridge and maintains the connection when links 224 or 226 with user device 206 or the PSAP 250 gets disconnected. In some embodiments, the EMS 230 attempts to re-establish links 224 and 226.

In some embodiments, the EMS 230 does not connect with the appropriate ESP (the emergency call is conducted via a native dial call by land phone or cellular phone carriers), but the EMS 230 acts as information bridge for the information about the emergency. The EMS 230 may provide access to emergency data comprising accurate location (device-based hybrid location), additional data and relevant social media data from the EAS 240 to the PSAP 250 via encrypted and trusted pathways. The emergency data may be saved in a clearinghouse 260, e.g., a social media database 260c (not marked). In some embodiments, the emergency data is provisioned using an emergency identifier (e.g., the phone number for device 206, user ID of user 220, Device ID or IP address of device 216, and others) via a secure and encrypted pathway.

### Emergency Clearinghouse

In some embodiments, as described above, the EMS 230 includes a clearinghouse 260 (also referred to as an “Emergency Clearinghouse”) for storing and retrieving emergency data including social media data. In some embodiments, the clearinghouse 260 includes a location clearinghouse 260a, an additional data clearinghouse 260b and a social media clearinghouse 260c. In some embodiments, the social media data may be included in the additional data clearinghouse, while in other embodiments, the social media data in a standalone. In other embodiments, social media data, additional data and location data (e.g., emergency data) are stored in one or more databases in a distributed manner. In some embodiments, the social media data is stored in an external or third-party server that is accessible to the EMS 230. The clearinghouse 260 can function as an interface that receives and stores emergency data from electronic or communication devices that may retrieved, transmitted, or distributed to recipients (e.g., emergency personnel) before, during, or after emergencies. As described above, the clearinghouse can receive emergency data from electronic or communication devices such as mobile phones, wearable devices, laptop or desktop computers, personal assistants, intelligent vehicle systems, home security systems, IoT devices, camera feeds, and other sources. As described above, emergency data may consist of locations, additional data such as medical history, personal information, or contact information or social media data (including relevant posts, relevant analytics, etc.). As will be described below, during an emergency, an ESP 250 (e.g., a PSAP) may query the clearinghouse 260 for emergency data pertaining to one or more current emergencies using emergency identifiers. The clearinghouse 260, which includes emergency data provisioned using an emergency identifier, then identifies if it has any emergency data pertaining to the emergency stored within the clearinghouse 260 and transmit the pertinent emergency data to the requesting ESP. The clearinghouse 260 may thus act as a data pipeline for ESPs otherwise without access to emergency data including social media data that may be critical to efficiently responding to the emergency. In particular, the social media data may include situational awareness regarding the emergency and other associated emergencies.

FIG. 3 illustrates an implementation of the proposed emergency assistance system (EAS), in accordance with an embodiment of the present disclosure. As shown, users can post content during an emergency to a social media application or network. The content is then collected and filtered to identify relevant social media content or data. This data can be stored in a database such as a NoSQL DB. An ESP user may then access and select from the data to share relevant content such as with a dispatcher at the ESP. This data sharing can be carried out using a visual tool, for example, a CAD interface allowing the dispatcher to view the content selected by the ESP user.

As shown in FIG. 3, the social media feed is inputted into the EAS (not shown). The social media feed typically includes posts published on a social media network (e.g., Twitter, Facebook, WhatsApp) by one or more users. As used herein, “social media network” refers to websites and applications that enable users to create and share content or to participate in social networking. From left to right, the “Overview” in FIG. 3 shows a process in which (1) users post content during an emergency to their social media application, (2) the system collects and filters content to identify or obtain relevant emergency data, (3) the system structures and stores the relevant data in a NoSQL database, (4) an ESP user (e.g., call taker, dispatcher, supervisor, manager, communications specialist) views and shares relevant content in visual tool, and (5) the dispatcher views relevant content in CAD from the communications specialist.

The social media feed may be accessed in various ways. For example, social media feeds can be access through APIs (Application Programming Interface). In some embodiments, the social media feed includes user status updates and page status updates in near real-time. In some embodiments, the social media feed is from a historical time frame, e.g., a past emergency. In some embodiments, the social media feed comprises XML-based objects. In some embodiments, the social media feed may include additional details about the posts to supplement the posts.

Data sources for social media feeds may be social media websites or networks, including but not limited to, Facebook, Twitter, Google Plus, YouTube, Spoke and LinkedIn. Additional data sources include, but are not limited to RSS feeds, blogs, comments on websites and websites themselves.

### Social Media Analysis

In some embodiments, the social media feed is analyzed to identify the relevant social media data determined to be pertinent to at least one current emergency situations. As used herein, a “current emergency” refers to an emergency for which the response is pending. In some embodiments, the analyzing is carried out in one or more stages.

In some embodiments, the analyzing is carried out in two stages. In the first stage, the social media feed is filtered using geo-bounding techniques and keywords to produce a filtered feed. The filtered feed may include filtered posts, which may include some keywords and are geo-bounded in the area of interest. One objective of the filtering stage is to reduce the volume of the social media feed using broad filters (e.g., location, emergency keywords, etc.) leaving a smaller volume of feed for detailed analysis. In this way, the computing power can be concentrated on a limited feed volume in the second stage. The broad filters for the first stage have to be designed to sweep in a significant portion of relevant feeds.

It is understood that various data may be included in the social media feed. For example, the social media data may include keyword search results, relevant posts, trending news or topics, hashtag tracking, campaign tracking, shares, reach, engagement, mentions, sentiment analysis, user tagging, image recognition, face recognition, virality, and influencer tracking. In addition to posts, the social media feed may include additional data such as user information, trending topics, etc.

### Geo-bounding

Geo-bounding refers to identifying the geographic location (e.g., x, y, and z coordinates or physical address) of the emergency associated with a social media post. In some cases, the location of the post is the location of the user when he or she uploaded the post to the social media network. In some cases, the location of the post is the location that is referred to in the post where the emergency is occurring or has occurred.

In some cases, social media posts have a tagged location, wherein the user has tagged the location. However, only a fraction of social media posts has a tagged location and the tagged location may not be accurate. In addition, the tagged location may not be location of the emergency. In many cases, the social media post and associated data is first searched for location information and location tagging. The location information may include one or more of check-in locations, tagged location, device-based location services, user address, IP address, name of image or video files, location of associates in user's network, etc. In some embodiments, a tagged location may be used for geo-bounding. In some embodiments, a tagged location may be analyzed for accuracy and used for geo-bounding after passing specific accuracy thresholds.

Geo-bounding can be particularly useful because the social media results can be bounded to the jurisdiction of a specific ESP (e.g., a PSAP, a police department, etc.). In some embodiments, social media feed is geo-bounded to the authoritative jurisdiction of an ESP (e.g., a PSAP). In some embodiments, the social media feed is geo-bounded to the assigned jurisdiction of an ESP. In some embodiments, the social media feed is geo-bounded based on a specific radius to a circular area using the location of the ESP as the center point. In some embodiments, location obtained from a social media network regarding the social media post is used for geo-bounding.

### Keywords

In some embodiments, a social media feed is filtered for keywords that are associated with emergencies. The list of key words can be tweaked to be encompassing such that most relevant posts are retained. The list of keywords can be adjusted by an administrator for the EAS. The keywords may be selected from “shooter”, “shooting”, “fire”, “flood”, “gun”, “violence”, “help”, “911”, “112”, “999”, “000”, “emergency”, “protest”, “punch”, “assault”, “heart attack”, “medical”, “broken”, “explosion”, “trapped”, “sinking”, “hurt”, “pain”, “suffering”, “storm”, “lighting”, “gas”, “attack”, “poison”, “lost”, “fell”, “fallen”, “smashed”, “mangled”, “earthquake”, “tsunami”, “ambulance”, “police”, “EMT”, “failure”, “FEMA”, and “disaster.”

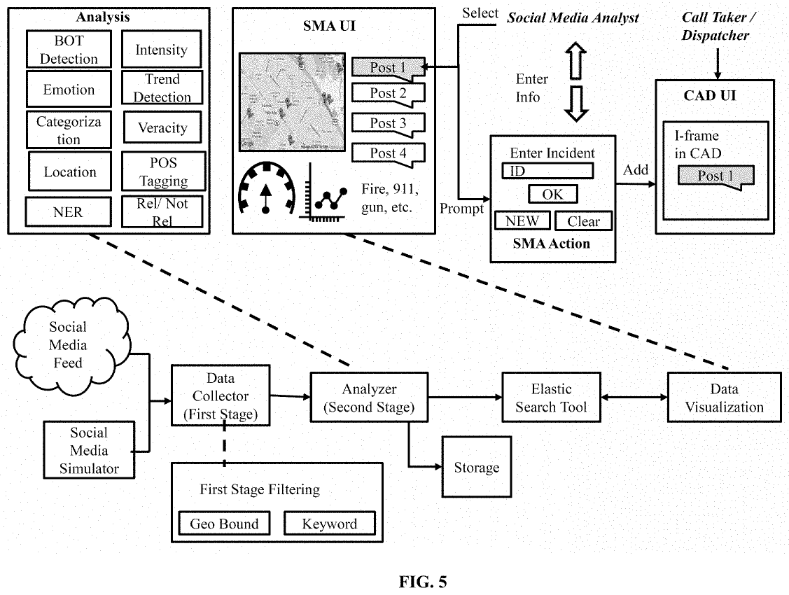

In some embodiments, the key words are updated based on specific threats. For example, when there is a Red Flag Warning issued for an area due to low humidity and high winds, the searches targeting the specific threats may be conducted with an updated list of keywords. Here, keywords related to fire emergencies (e.g., “fire”, “wildfire”, etc.) may be used for the search targeting fires. In a similar way, it is contemplated that other searches targeting specific threats may be generated including terrorist threats, infectious disease threats, etc. In a similar way, keyword updates may be done when one or more current emergencies have been identified in relevant posts (see FIG. 5) by, for e.g., using key words in the relevant posts to find other relevant posts.

In the second stage, the filtered feed from the first stage is processed to produce the relevant social media data. In some embodiments, the social media feed is analyzed for one or more of bots, emotion, categorization, location, named entity recognition (NER), intensity, trend, veracity, tagging, part-of-speech (POS) tagging and sentiment analysis.

### Natural Language Processing

In some embodiments, natural language processing is done in the second stage of analysis of the social media feed. Specifically, the filtered feed may be inputted into one or more NLP module for evaluating relevancy. NLP algorithms deal with how to program computers to process and analyze large amounts of natural language data and may involve speech recognition, natural language understanding, and natural language generation. NLP allows human-computer interaction for automatic text summarization, sentiment analysis, topic extraction, named entity recognition, parts-of-speech tagging, relationship extraction, stemming, text mining, machine translation, and automated question answering.

Instead of hand-coding large sets of rules for language, NLP algorithms can rely on machine learning to automatically learn these rules by analyzing a set of examples (e.g., a large corpus, like a book, down to a collection of sentences), and making a statistical inference. In general, analyzing a large volume of good training data leads to more accurate NLP models and algorithms. Thus, the role of historical data for training the NLP algorithms in the “social media simulator” as shown in FIG. 5 will lead to more accuracy.

In the context of emergencies, it is appreciated that high accuracy and precision for the analysis may not be desirable in all cases. For example, in the case of suicide prevention, the algorithm may be designed to maximize recall over precision during pattern recognition. In this way, a user who is not likely to follow through on suicide are also identified and can be provided appropriate assistance.

In many cases, NLP is suited for analyzing vast amounts of social media data. For example, sentiment analysis can be powerful in evaluating social media posts and classifying the text as positive, negative or neutral. NLP can be used for evaluating various social media analytics like trending topics. NLP can also be used for detecting bots, monitoring for malicious digital attacks, such as phishing, or detecting when somebody is lying.

It may be appreciated that, in order to issue the request to ESPs, the EAS needs to be sure that the post is authentic and/or the poster or user sharing the post is authentic and is not a prank. In order to confirm the authenticity of the user and/or the authenticity of the post, the EAS of the present disclosure transmits the relevant social media feed after checking for bots, veracity, etc.

### Algorithms

In some embodiments, the systems, methods, and media described herein use one or more algorithms analyzing social media content. In some embodiments, machine learning algorithms are used for training prediction models and/or making predictions such as predicting whether a social media post or information from the social media post is relevant to an emergency. In some embodiments, the algorithm predicts a degree of relevance to an emergency. Various algorithms can be used to generate models that are used to identify one or more social media posts or content that is relevant to an emergency. In some instances, machine learning methods are applied to the generation of such models.

In some embodiments, a machine learning algorithm uses a supervised learning approach. In supervised learning, the algorithm generates a function from labeled training data. Each training example is a pair consisting of an input object and a desired output value. In some embodiments, an optimal scenario allows for the algorithm to correctly determine the class labels for unseen instances. In some embodiments, a supervised learning algorithm requires the user to determine one or more control parameters. These parameters are optionally adjusted by optimizing performance on a subset, called a validation set, of the training set. After parameter adjustment and learning, the performance of the resulting function is optionally measured on a test set that is separate from the training set. Regression methods are commonly used in supervised learning. Accordingly, supervised learning allows for a model or classifier to be generated or trained with training data in which the expected output is known in advance such as when the relevance is known (e.g., based on feedback to relevant posts by an analyst at an ESP). For example, an analyst at an ESP may further screen or select posts that are of sufficient relevance to be shown or displayed to a call taker or dispatcher. Such actions by the analyst can be recorded as historical data to be used to train or further improve the model(s) used to predict relevance of social media posts.

In some embodiments, a machine learning algorithm uses an unsupervised learning approach. In unsupervised learning, the algorithm generates a function to describe hidden structures from unlabeled data (e.g., a classification or categorization is not included in the observations). Since the examples given to the learner are unlabeled, there is no evaluation of the accuracy of the structure that is output by the relevant algorithm. Approaches to unsupervised learning include: clustering, anomaly detection, and neural networks.

In some embodiments, a machine learning algorithm learns in batches based on the training dataset and other inputs for that batch. In other embodiments, the machine learning algorithm performs on-line learning where the weights and error calculations are constantly updated.

In some embodiments, a machine learning algorithm is applied to new or updated emergency data to be re-trained to generate a new prediction model. In some embodiments, a machine learning algorithm or model is re-trained periodically. In some embodiments, a machine learning algorithm or model is re-trained non-periodically. In some embodiments, a machine learning algorithm or model is re-trained at least once a day, a week, a month, or a year or more. In some embodiments, a machine learning algorithm or model is re-trained at least once every 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days or more.

In some instances, machine learning methods are applied to select, from a plurality of models generated, one or more particular models that are more applicable to certain attributes. In some embodiments, different models are generated depending on the distinct sets of attributes obtained for various communications.

In some embodiments, the classifier or trained algorithm of the present disclosure comprises one feature space. In some cases, the classifier comprises two or more feature spaces. In some embodiments, the two or more feature spaces are distinct from one another. In various embodiments, each feature space comprise types of attributes associated with social media content such as the type of social media network, location associated with the content or post, and other attributes. In some embodiments, the accuracy of the classification or prediction is improved by combining two or more feature spaces in a classifier instead of using a single feature space. The attributes generally make up the input features of the feature space and are labeled to indicate the classification of each communication for the given set of input features corresponding to that communication.

In some embodiments, an algorithm utilizes a predictive model such as a neural network, a decision tree, a support vector machine, or other applicable model. Using the training data, an algorithm is able to form a classifier for generating a classification or prediction according to relevant features. The features selected for classification can be classified using a variety of viable methods. In some embodiments, the trained algorithm comprises a machine learning algorithm. In some embodiments, the machine learning algorithm is selected from at least one of a supervised, semi-supervised and unsupervised learning, such as, for example, a support vector machine (SVM), a Naïve Bayes classification, a random forest, an artificial neural network, a decision tree, a K-means, learning vector quantization (LVQ), regression algorithm (e.g., linear, logistic, multivariate), association rule learning, deep learning, dimensionality reduction and ensemble selection algorithms. In some embodiments, the machine learning algorithm is a support vector machine (SVM), a Naïve Bayes classification, a random forest, or an artificial neural network. Machine learning techniques include bagging procedures, boosting procedures, random forest algorithms, and combinations thereof.

In some embodiments, a machine learning algorithm such as a classifier is tested using data that was not used for training to evaluate its predictive ability. In some embodiments, the predictive ability of the classifier is evaluated using one or more metrics. These metrics include accuracy, specificity, sensitivity, positive predictive value, negative predictive value, which are determined for a classifier by testing it against a set of independent cases (e.g., communications). In some instances, an algorithm has an accuracy of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances, an algorithm has a specificity of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances, an algorithm has a sensitivity of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances, an algorithm has a positive predictive value of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein. In some instances an algorithm has a negative predictive value of at least about 75%, 80%, 85%, 90%, 95% or more, including increments therein, for at least about 50, 60, 70, 80, 90, 100, 110, 120, 130, 140, 150, 160, 170, 180, 190, or 200 independent cases, including increments therein.

In some embodiments, the multimedia content undergoes natural language processing using one or more machine learning algorithms. In some embodiments, the one or more machine learning algorithms utilize word embeddings that map words or phrases to vectors of real numbers. In some embodiments, the mapping is generated by a neural network. In some embodiments, a machine learning algorithm is applied to parse the text obtained from social media content (e.g., extracted text from a posted video or audio recording). In some embodiments, a machine learning algorithm is applied to segment words into morphemes and identify the class of the morphemes. In some embodiments, a machine learning algorithm is applied to identify and/or tag the part of speech for the words in the multimedia content (e.g., tagging a word as a noun, verb, adjective, or adverb). In some embodiments, a machine learning algorithm is applied to classify social media content into a category such as relevance (e.g., relevant or irrelevant to an emergency). In some embodiments, the application applies at least one machine learning algorithm to social media content to determine an emergency type (e.g., injury or accident, medical problem, shooting, violent crime, robbery, tornado, or fire) and/or emergency level (e.g., safe, low, medium, high).

### Security, Privacy, Trust & Reliability of Social Media Information

In some embodiments, the information collected by the EAS (e.g., for the Emergency Registry) may be kept confidential and access to the information may be restricted. In some embodiments, the data may be anonymized to protect privacy. To reduce risk of a data breach, the data may be shared through secure and encrypted pathways.

Authorization and credential management for ESP users may allow differential access to requesting parties. In some embodiments, data is queried over public networks by using API access keys or credentials. In some embodiments, Transport layer Security (TLS) is used in the queries for encryption. In some embodiments, authorization is provided in the “Authorization” header of the query using HTTP Basic Authentication. For example, in some embodiments, authorization is base64-encoded user name and password for the account.

Many social media websites, as well as other websites, allow reviews and other comments to be posted by users. Privacy and reliability issues exist with information posted on social media. It is also possible that the publicly available profile provided by the user is blank, anonymous or deliberately misleading. The user's post may be mimicking human activity but in fact be an automated robot, with an assumed biased party directing the robot.

In some embodiments, a verification process is implemented to establish the veracity of information. In some embodiments, the verification is implemented through corroboration, e.g., the name of the user is the same from different sources (e.g., the name is same on FB and in an online people directory). In other embodiments, the verification process may involve another user confirming the information by email, text message, etc. regarding the user or the situation.

In some embodiments, for the verification process, the source of the post is considered for trustworthiness. In one embodiment, the source is a factor of trust. For example, a governmental agency, such as the Federal Emergency Management Agency (“FEMA”) may be given a higher degree of trust as compared to a television news channel's RSS feed or a social media site. Similarly, certain non-governmental agencies, such as the International Red Cross may be given a trust value higher than other sources.

The present disclosure recognizes the advantages that can be obtained from prioritizing one or more specific NLP parameters to improve accuracy. In some embodiments, sentiment in the social media feed is prioritized in the analysis. In some embodiments, frequency or the number of posts related to an emergency situation can be prioritized in the analysis. In some embodiments, the social media feed is prioritized based on type of emergency. Thus, medical emergencies may be analyzed differently as compared to police emergencies. In some embodiments, severity of the emergency is evaluated in the social media feed and the analysis prioritizes more severe emergencies. Thus, a more severe emergency may be placed on the top of relevant post results as depicted in FIG. 5.

In addition to machine learning, certain embodiments of the present disclosure utilize statistical methods for analysis of social media content. Some advantages of statistical methods (e.g., logistic regression) are that they are less complex and may require less data and computing power. The algorithm may use statistical tools/methods to compare historical data for social media around emergencies in order to generate a relevancy model that correlates the relationship between the social media feed with emergencies.

As described with regards to FIG. 4, the relevant social media data can be updated when more current social media data is available. The updates may be available in periodic intervals (e.g., every 5 minutes) during the duration of the emergency. In some embodiments, the updates are available on a real-time or near real-time basis as social media data becomes available. After relevant posts have been identified, updates to the relevant social media data can be made whenever a new post is available from one of the users who posted the relevant posts. In some embodiments, trending topics in the relevant posts are updated using the trending topics, hashtag, or other parameters. In some embodiments, the trending topics and/or hashtags are shown on a map, which is optionally updated in near real-time basis to view the affected area. Further details about mass emergencies are available in FIG. 5. In addition to updates to the social media data, in certain embodiments, the analysis algorithms are improved through training and testing data based on ESP user actions. Further details about improving analysis algorithms are available in FIG. 5.

### Statistical Methods—Regression & Non-Regression Analysis

In some embodiments, regression analysis is used to generate models for social media content, in particular for determining relevancy with regards to current emergency situations. Regression analysis is a class of modeling techniques that uses data to establish a mathematical relationship between different variables (features). In some embodiments, regression analysis is linear regression. In linear regression, the dependent variable is a numerical outcome. Relevancy models for the dependent variable are modeled using a linear combination of the predictor variables (or transformed predictor variables). The unknown model parameters are then estimated from the data.

In some embodiments, regression analysis is logistic regression. In logistic regression, the dependent variable is a binary outcome (e.g., yes/no, usually coded as 1/0). A logistic model is used to estimate the probability of the binary outcomes (instead of the exact outcome) based on one or more variables. In some embodiments, for example, logistic regression allows a determination as to whether the presence of a feature (variable) increases the probability of a given outcome by a specific percentage.

In some embodiments, a non-regression based analysis is used in the systems, methods, and media described herein. An example of a non-regression based analysis is time series analysis. Time series analysis comprises methods for analyzing time series data in order to extract meaningful statistics and other characteristics of the data. Time series forecasting uses a model to predict future relevancy values based on previously observed relevancy values.

### Data Structure & Storage

After analysis, the relevant social media data is organized in a specific structure. In some embodiments, the data structure is designed for searchability, reliability and/or computing efficiency. In some embodiments, data structure layers such as Elasticsearch are utilized for social media data.

In some embodiments, after the social media data is structured, it is stored in a database or data service. In some embodiments, the relevant social media data is stored in a NoSQL database. For example, the social media data may be stored in Elasticsearch, Amazon Web Services (AWS) and/or Amazon Elastic Compute Cloud (Amazon EC2). Use of other services and databases suitable for this purpose is also contemplated.

Various data visualization tools may be used for viewing and displaying the relevant social media data for an ESP user (e.g., a social media analyst, a communication specialist, an ESP supervisor). For example, in some embodiments, Kibana visualization tool is used for visualizing the relevant social media data including social media analytics such as trending and keywords, as shown in FIG. 5.

In some embodiments, the relevant social media data is integrated into displays or screens for other ESP users (e.g., call takers, dispatchers, emergency responders). Research suggests that raw social media data is helpful for emergency response. Specifically, the raw social media data may include information that will be helpful for the emergency response and should be displayed if it is relevant. As a result, the relevant social media data may include the raw social media content in addition to analytics and summarization. For example, the social media data may be incorporated into CAD screens for dispatchers to view when sending responders to the emergency location. With the additional information from social media, the dispatchers may be able to send appropriate personnel and equipment.

FIG. 4 illustrates an embodiment of the flow used by the emergency assistance system (EAS) for sending linking relevant social media data with a current emergency in accordance with an embodiment of the present disclosure. As shown, a social media analyst (e.g., analyst 270 in FIG. 2) may be accessing relevant results from an EAS (e.g., EAS 240 in FIG. 2) from a real-time or near real-time social media feed, such as a Twitter feed. In Step A, the analyst selects a message or post from the relevant social media data displayed in the social media analyst UI 475. For example, the post may be about an active shooter event in a school. Next, analyst will be prompted to enter an incident ID for the emergency in Step B. In the meantime, the call taker receives an emergency call from one of teachers in the school regarding the shooting and creates an incident ID in the CAD system in Step C. When the analyst is prompted, she checks the CAD system using the CAD UI for the incident ID for a shooting near the reported location in Step D. In Step E, the incident ID for the shooting is retrieved from the CAD system by the analyst. In Step F, the analyst enters the ID into the social media UI to link it to the post regarding the shooting, which causes a new I-frame to be generated in CAD in Step G. In this way, the teacher's post about the shooting will be displayed in CAD for the call taker or dispatcher to view.

As illustrated above, the relevant social media posts can be delivered to an appropriate ESP within a mini-browser window. It is desirable for the ESP user who is going to be responding to an emergency be given access to relevant posts on social media so that he or she can evaluate how the information might impact the response. In particular, the ESP user may be able to review context, tone, presentation in the raw social media posts on the native platforms (which may be lost if re-formatted in another application or alternate platform).

For this purpose, various types of browser windows may be used to upload the social media web page with the specific relevant posts for the ESP user. In some embodiments, the relevant posts may be loaded on a full window, which would allow the ESP user to view the social media platform, but might take up a significant part of the screen for the ESP user. In some embodiments, mini-browser windows may be used so that they take up a small portion of the screen space. In some embodiments, mini-browsers includes I-frame, AJAX, or HTML5. Depending on importance of social media data for a particular ESP role, preferences of the ESP agency or ESP user, different types of browser windows may be chosen.

The social media data may be updated in various ways. For example, in some embodiments, the EAS generates a new set of relevant data periodically. Alternatively, certain embodiments of the CAD system in the ESP check for updates while the incident ID is still active. For example, as shown in the embodiment of FIG. 4, the CAD system checks for new I-frame in Step H. If the teacher has posted an updated message with an image of wounded victims, that message in addition to the original post is optionally picked up in the updated I-frame in Step I and displayed to call taker or dispatcher in Step J. The call taker/dispatcher can use the social media data in the I-frame (e.g., the image of wounded victims) to decide how many ambulances to dispatch to the emergency location (Step K). When the emergency ends (e.g., the response phase has been completed), the call taker or dispatcher closes the incident ID in the CAD system (Step L). To save memory, the I-frame is deleted in Step M.

Push to PSAP

In some situations, emergency alerts may be generated without an associated emergency call. An ESP user (e.g., a social media analyst, a PSAP supervisor, etc.) may see the incident on the interactive map, but not be assigned to take a call. An ESP user (e.g., a PSAP supervisor) may review the emergency alert and may determine that an emergency response is warranted. In such situations, the “push to PSAP” is initiated by sending the emergency alert from the user device to the EMS. The ESP user may accept the “push to PSAP” by creating an incident in CAD as described below.

It is contemplated that “push to PSAP” will be a valuable functionality as there is currently limited pathways into the PSAP (e.g., by emergency calls or texts in some jurisdiction). In this way, users and user devices can get access to emergency response through alternate pathways.

FIG. 5 illustrates an EAS, in accordance with an embodiment of the present disclosure. As depicted, social media simulator takes in historical social media feed for training the analysis algorithms for training machine-learning algorithms. The algorithm uses statistical tools/methods (e.g., logistic regression) to compare historical data for social media around emergencies in order to generate a relevancy model that correlates the relationship between the social media feed with emergencies.

Various formats for the social media feed are contemplated. In some embodiments, the social media feed is stored in JavaScript Object Notation (JSON) format as it is both easy for humans to read and machines to parse.

In some embodiments, real-time or near real-time social media feed (in JSON or another format) may be inputted into the Data Collector (the first stage of analysis). Here, geo-bounding and keywords are used for filtering the social media feed to produce a filtered feed as described with respect to FIG. 3. Next, the second stage of analysis is conducted in the Analyzer. For example, the analyzer may use NLP algorithms to analyze the filtered feed for detecting Bots, intensity, emotion, trends, categorization, veracity, location, POS tagging, NER, “relevant” or “not relevant.” The result from the analyzer is the relevant social media data including one more relevant posts and additional data (e.g., trends & keywords). In some embodiments, the results can be downloaded and stored. In some embodiments, the results are stored and can be searched using a tool such as the Elastic Search Tool.

Subscription Method

In some embodiments, the EMS pushes emergency data to one or more appropriate ESPs (e.g., one primary agency, and one or more secondary agencies) using an emergency data subscription system. Using the emergency data subscription, a recipient (or potential recipient) of emergency data from the clearinghouse can subscribe to the clearinghouse for a particular device identifier, user identifier (e.g., social media identifier), or ESP account (hereinafter, “subscription”). After subscribing to a subscription, the recipient (e.g., an ESP) may automatically receive updates regarding the subscription without first sending an emergency data request. For example, in some embodiments, if an ESP subscribes to messages from a user account in its jurisdiction, whenever the clearinghouse receives updated emergency data associated with the user account, the clearinghouse can automatically send the updated emergency data associated with the phone number to the ESP (e.g., through the emergency response application), without first receiving an emergency data request including the phone number.

In some embodiments, if a recipient is subscribed to specific hashtags or keywords associated with an emergency within its jurisdiction, and the clearinghouse receives a new posts with that hashtag or keywords, the clearinghouse will instantly and automatically push the new relevant posts to the recipient, without the recipient having to send an emergency data request. In some embodiments, when an ESP user accesses the emergency response application at a computing device associated with the ESP user, the EMS establishes a WebSocket connection with the computing device in order to push emergency data regarding a subscription to which the ESP or ESP user (via an ESP account) is subscribed to the emergency response application. WebSocket is a type of computer communications protocol. A WebSocket connection is a longstanding internet connection between a client and a server that allows for bidirectional communication between the client and server without the client needing to send data requests to the server, which differentiates the WebSocket computer communications protocol from other types of computer communications protocols such as the HyperTextual Transfer Protocol (HTTP). The WebSocket protocol is often used by chat clients to facilitate user to user webchats. In some embodiments, the EMS establishes a WebSocket connection with a computing device (e.g., an ESP console) in response to receiving an emergency data request.

In some embodiments, the EMS establishes a WebSocket connection with an ESP console when an ESP personnel logs into the emergency response application at the ESP console. In some embodiments, the EMS establishes a WebSocket connection with a responder device when an ESP personnel logs into the emergency response application at the responder device. In some embodiments a WebSocket connection established between the EMS and a computing device associated with ESP personnel is maintained by the EMS for the duration of the ESP personnel's log-in session.

It is understood that various data visualization tools may be used for viewing the social media data. An SMA UI is depicted in FIG. 5. As shown, the social media data may include one or more relevant posts. In some embodiments, the relevant posts are displayed in a ranked list. In some embodiments, the relevant posts are displayed in a prioritized list wherein the severity of the emergency is used for determining the posts priority. Thus, Post 1 may be pertinent to a more severe emergency (“Help! My friend has fallen from a ledge!”) as compared to Post 4 (“Confession: what is wrong with suicide? Sometimes, it is the only way . . . ”). In addition to the relevant posts, the relevant social media data may include additional data such as social media analytics such as trending topics, intensity meter, geo-bounded maps, keywords found, etc. The additional data may be helpful for the analyst to view in addition to the raw data (e.g., the relevant posts).

In some embodiments, when an ESP personnel or ESP user accesses an emergency response application at a computing device associated with the ESP user, the EMS establishes a WebSocket connection with the computing device in order to push emergency data regarding a subscription to which the ESP user is subscribed to the emergency response application (e.g., based on credentials of the ESP and geofence associated with ESP). WebSocket is a type of computer communications protocol. A WebSocket connection is a longstanding internet connection between a client and a server that allows for bidirectional communication between the client and server without the client needing to send data requests to the server, which differentiates the WebSocket computer communications protocol from other types of computer communications protocols such as the HyperTextual Transfer Protocol (HTTP). The WebSocket protocol is often used by chat clients to facilitate user to user webchats. In some embodiments, the EMS establishes a WebSocket connection with a computing device with an ESP console (e.g., SMA UI, call-handing UI, CAD UI) in response to receiving an emergency data request. In some embodiments, the EMS establishes a WebSocket connection with an ESP console when an ESP personnel logs into the emergency response application at the ESP console. In some embodiments, the EMS establishes a WebSocket connection with a responder device when an ESP user logs into the emergency response application at the responder device. In some embodiments a WebSocket connection established between the EMS and a computing device associated with ESP user is maintained by the EMS for the duration of the ESP user's log-in session.

Social Media Analyst

In some embodiments, the ESP user is a social media analyst. In some embodiments, the social media analyst plays an important role for determining if and when social media data is shared with other ESP users. Many ESP users (e.g., call takers and dispatchers) have to make quick decisions regarding emergency response. Thus, it is important to strike a balance between sharing everything that might be relevant and not sharing a critical piece of information that can save lives. An analyst or other ESP user (call taker/dispatcher) are best situated to determine whether to share information with other ESP users, such as emergency responders.

As compared to a fully automated system where no input from ESP users are taken into account, certain embodiments of the present methods and systems combine the advantages of automation with human input and is specifically suited for the emergency response. Automation is helpful is reducing the massive volume of social media data into a smaller subset that can be reviewed by humans. In addition, humans are still best suited for understanding relevance of the social media posts (particularly from the raw data), for e.g., detecting sarcasm, parody and other nuances. There are wide disparities in how emergency services and dispatch centers (e.g., PSAPs) are organized at a local level. Thus, input from an ESP user can allow the present methods and systems to be tailormade for each locality.

In addition, when the social media analyst takes any action in the SMA UI screen, it can provide critical feedback to improve the results from the analysis. The action of the ESP user includes selection of a relevant post or trending topics, follow-up searches, linking the post to one or more incident IDs, feedback regarding the quality of data, marking posts as helpful or not helpful, inputting the outcome or fatalities that have occurred in the emergency, or other responses to the social media data. In some embodiments, the analysis algorithm is improved by supervised learning based on the analyst's actions. In some embodiments, the analysis is improved by other methods. In some embodiments, the analyst actions are used to check the error rate of the model and update the model parameters (e.g., for regression analysis).

Although a specific role for a social media analyst or communication specialist is contemplated, it is understood that any ESP user may function in this role. For example, a call taker may receive an emergency call regarding a fire. The call taker may have access to the social media analyst screen (similar to the SMA UI screen in FIG. 5) on one of their side screens and quickly scan through the relevant posts and trending topics to see if there is situational awareness from the social media feed. In this example, when the call taker gets the call regarding the fire and notices there are several posts regarding fires in the neighborhood, he or she may get an idea about the extent of the fire. When advising the person in the emergency, the call taker may be able give advice regarding the response and what to do to get out of the fire affected based on the situational awareness from the social media feed (e.g., avoid the third floor as the fire has spread there). It is contemplated that dispatchers, supervisors, managers and emergency responders can use the social media data for improving emergency response and planning.

### Computer-Aided Dispatch Software

Computer-aided Dispatch (CAD) refers to a host of software that are designed for dispatching of taxicabs, couriers, field service technicians, mass transit vehicles, and emergency responders. In the public safety space, CAD software may support call taking, dispatch, and status maintenance of emergency responders. It is contemplated that the present system, methods, and devices may be integrated with any CAD software for displaying relevant social media data.

In some embodiments, a unique identifier for the emergency is generated in the CAD software for initiating a response. In some embodiments, the unique identifier is an incident ID, an event ID, an emergency ID, or a phone number (which may be generally referred to as a CAD incident).

### Mass Casualty Incidents & Mass Emergencies

Mass Casualty Incidents (MCIs) are understood to be incidents or emergencies where the emergency service personnel and equipment are overwhelmed by the number or severity of casualties or injuries. Typically, the MCI designation is based on the resources that are ordinarily available in the locality. With disaster planning (e.g., an extreme weather warning), additional resources that are not ordinarily available in the locality can be used. In many cases, the emergency phone lines may be overwhelmed leading to busy emergency lines, dropped calls or long wait times. ESPs (e.g., PSAPs) may have varying criterion and response plans for MCIs.

Mass emergencies, as used herein, refers to one or more related emergencies that affects a group of people or has a high likelihood of affecting a group of people. In some embodiments, the mass emergency may affect 10-100 people, wherein the 10-100 people may need emergency assistance. In some embodiments, the mass emergency affects more than 25 people, wherein 25 people may need emergency assistance. In some embodiments, the mass emergency may affect less 10 people, but there is a likelihood of high severity.

Social media may be particularly powerful means of communication when emergency services have been overwhelmed or when a large group of people have been affected by one or more emergencies. If the Internet connectivity has not been affected, increase in social media activity can be used for early detection and efficient emergency response during MCIs and mass emergencies. In some embodiments, relevant posts and social media analytics are indicative of a mass emergency. In particular, in certain embodiments, mass emergencies are detected using analytics such trending topics or hashtags, social media content volume and key word sentiment severity.

FIG. 6 illustrates screens for PSAPs, in accordance with an embodiment of the present disclosure. Screen A shows that a user has shared a live feed from an on-going shooting on a social media network (e.g., Facebook) on the user's device. The live feed will be analyzed by the EAS and included in the relevant social media data that is displayed in Screen B (e.g., SMA UI) for a communication specialist. In addition to the live feed, the shooting may be a trending topic in the relevant social media data. In Screen C, the communication specialist is able to select a post for linking to a unique ID (e.g., an incident ID in CAD). Because of the linking, the relevant social media data (relevant posts including live feed and trending topics data) is visible in Screen D1 in CAD for call takers and dispatchers. Screen D2 shows another screen where the social media data is displayed in CAD in addition to a UI for the call taker or dispatcher to have follow-up communication with the communication specialist. For example, the follow-up communication may be acknowledging receipt of the live feed, asking for additional information or additional searches, providing update on response, or providing other feedback or communication. For example, the dispatcher may ask for a specific search of social media regarding the shooting in the school to see if there are reports of the suspect outside the school premises. As another example, if the live feed identifies two victims, then the dispatcher may let the communication specialist know that two ambulances have been dispatched. If the communication specialist sees information about more victims, he or she may let the dispatcher know so that more paramedics are dispatched to the emergency location.

### Certain Terminologies

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, a “user” refers to one or more person or persons associated with a system, server, or device (e.g., electronic device, communication device, mobile phone, smartphone, computer, etc.). In some embodiments, a device associated with a user is a device carried or worn on the person of the user (e.g., a phone or wearable device). In some embodiments, a device associated with a user is not carried or worn on the person of the user (e.g., a home security sensor or camera installed in the home of the user, a vehicle tracking system installed in a vehicle of the user, etc.). As used herein, an “ESP user” refers to a user of the ESP system who has authorization access the ESP computer system.

As used herein, “data” refers to a collection of information about one or more entities (e.g., user of a user communication device) and/or an environment that pertains to characteristics of the one or more entities. In some embodiments, an entity is a person such as a user. In some embodiments, an entity is a thing (e.g., a house). For example, in some embodiments, data comprises sensor data from home sensors associated with a house. In this example, the data is also associated with one or more persons (e.g., the homeowner(s) and/or inhabitant(s)). In some embodiments, data refers to meta-data. In some embodiments, data comprises health information about the user of a communication device. In some embodiments, data comprises information about the surrounding environment of the user of the user communication device (e.g., surrounding temperature, location, elevation, barometric pressure, ambient noise level, ambient light level, surrounding geography, etc.). In some embodiments, data comprises information about other users that is pre-stored in a device or in a database (e.g., a database within a group of devices who are related to the user of the user communication device as predefined by the user). In some embodiments, the data set comprises information from two or more users of user communication devices, wherein each user is affected by an emergency situation. As an example, two unrelated users are involved in a vehicular collision, and each user sends a separate emergency alert (for traffic accident) using his/her communication device. In this example, the separate emergency alerts are associated (e.g., by an emergency assistance system and/or emergency dispatch center) with the same emergency based on the proximity of time, location, and emergency indication of the emergency requests. As a result, the data set for this accident comprises information from both user communication devices. In this example, the data comprises location data from both devices (e.g., GPS coordinates), biosensor data for one or both devices (e.g., biosensor data such as heart rate and blood pressure can be important in case of injury), and information about the vehicle driven by each user (e.g., make, model, and year of manufacture information stored on the device).

As used herein, “health data” refers to medical information associated with a user of a device. In some embodiments, health data comprises medical history such as, for example, past illnesses, surgery, food and/or drug allergies, diseases, disorders, medical diagnostic information (e.g., genetic profile screen), or any combination thereof. In some embodiments, health data comprises family medical history (e.g., family history of breast cancer). In some embodiments, health data comprises current health information such as, for example, current symptoms, current medications, and/or current illnesses or diseases. In some embodiments, health data comprises user age, height, weight, blood type, and/or other biometrics. In some embodiments, medical history comprises medical information that is equal to or more than 1, 2, 3, 4, 5, 6, 7, 8, 9, 10, 11, 12, 13, 14, 15, 16, 17, 18, 19, 20, 21, 22, 23, or 24 hours old. In some embodiments, medical history comprises medical information that is equal to or more than 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days old. In some embodiments, current health information comprises information that is equal to or less than 1, 2, 3, 4, 5, 6, 7, 8, 9, 10, 11, 12, 13, 14, 15, 16, 17, 18, 19, 20, 21, 22, 23, or 24 hours old. In some embodiments, current health information comprises medical information that is equal to or less than 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 days old.

As used herein, “user data” refers to general information associated with a user of a device. In some embodiments, user data comprises user identity, user name, height, weight, eye color, hair color, ethnicity, national origin, religion, language(s) spoken, vision (e.g., whether user needs corrective lenses), home address, work address, occupation, family information, user contact information, emergency contact information, social security number, alien registration number, driver's license number, vehicle VIN, organ donor (e.g., whether user is an organ donor), or any combination thereof. In some embodiments, user data is obtained via user input.

As used herein, “sensor data” refers to information obtained or provided by one or more sensors. In some instances, a sensor is associated with a device (e.g., user has a communication device with a data link via Bluetooth with a wearable sensor, such as, for example, a heart rate monitor or a pedometer). Accordingly, in some embodiments, the device obtains sensor data from the sensor (e.g., heart rate from the heart rate monitor or distance traveled from the pedometer). In some instances, the sensor data is relevant to an emergency situation (e.g., heart rate during a cardiac emergency event). In some embodiments, a sensor and/or sensor device comprises an acoustic sensor, a breathalyzer, a carbon dioxide sensor, a carbon monoxide sensor, an infrared sensor, an oxygen sensor, an ozone monitor, a pH sensor, a smoke detector, a current sensor (e.g., detects electric current in a wire), a magnetometer, a metal detector, a radio direction finder, a voltage detector, an air flow meter, an anemometer, a flow sensor, a gas meter, a water meter, a Geiger counter, an altimeter, an air speed indicator, a depth gauge, a gyroscope, a compass, an odometer, a shock detector (e.g., on a football helmet to measure impact), a barometer, a pressure gauge, a thermometer, a proximity sensor, a motion detector (e.g., in a home security system), an occupancy sensor, or any combination thereof, and in some embodiments, sensor data comprises information obtained from any of the preceding sensors. In some embodiments, one or more sensors are physically separate from a user device. In further embodiments, the one or more sensors authorize the user device to obtain sensor data. In further embodiments, the one or more sensors provide or send sensor data to the user device autonomously. In some embodiments, the user device and the one or more sensors belong to the same group of devices, wherein member devices are authorized to share data. In some embodiments, a user device comprises one or more sensors (e.g., user device is a wearable device having a sensor or sensing component).

As used herein, a “911 authority” refers entities or organizations that have been given authority by the government to service 911 or emergency calls within a specific area (the “authoritative region”). Examples of 911 authorities include PSAPs and various types of PSS such as emergency command centers.

As used herein, an emergency service provider (ESP) refers to any individual, agency, or institution (public or private) that provides emergency services. ESPs include, but are not limited to PSSs, as described above, emergency dispatch centers (e.g., PSAPs), private entities (e.g., tow truck operators/agencies). The ESP agency refers to the entity or organization, which typically has one or more administrators. In addition, the ESP may include one or more staff members. In some embodiments, emergency responders may be members of the ESP.

Each type of ESP agency (PSS, PSAP, private entities) may have an identifier to identify the agency. The ESP identifier can be the ESP organization name, ESP organization ID, FCC identifier and IP address, or another identifier. In a similar way, the PSS and PSAP may have a PSS identifier and a PSAP identifier.

As used herein, an “emergency responder” refers to any person or persons responsible for addressing an emergency situation. A first responder is a specific type of emergency responder. In some embodiments, a first responder refers to government personnel responsible for addressing an emergency situation. In some embodiments, an emergency responder is responsible for a particular jurisdiction (e.g., a municipality, a township, a county, etc.), also referred to as its authoritative jurisdiction. In some embodiments, an emergency responder is assigned to an emergency by an emergency dispatch center (hereinafter, “EDC”) or an emergency service provider (ESP), such as a PSS or a PSAP. In some embodiments, an emergency responder responds to a request for emergency assistance placed by a user via a communication device. In some embodiments, an emergency responder includes one or more firefighters, police officers, emergency medical personnel, community volunteers, private security, security personnel at a university, or other persons employed to protect and serve the public and/or certain subsets of the population.

In many cases, the emergency responder communicates with the dispatching organization (e.g., a PSS or PSAP) through a responder device. In many cases, the responder device is a mobile device that the responder carries (e.g., smartphone, tablet, radios, walkie talkies, or travels with (e.g., vehicular console), etc. In some embodiments, the responder devices are configured to receive and update emergency data through secure and encrypted pathways. In addition, the responder devices may include security and privacy measures to protect emergency information.

As used herein, a public safety answering point (PSAP) refers to a call center responsible for answering calls to an emergency telephone number for police, firefighting, and ambulance services. Trained telephone operators (also referred to as call-takers) are also usually responsible for dispatching these emergency services. The Federal Communications Commission (FCC) of the United States government maintains a PSAP registry. The registry lists PSAPs by an FCC assigned identification number, PSAP Name, State, County, City, and provides information on any type of record change and the reason for updating the record. The FCC updates the registry periodically as it receives additional information.

### Digital Processing Device

In some embodiments, the platforms, media, methods and applications described herein include a digital processing device, a processor, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device. In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetB SD®, Linux, Apple® Mac OS X Server®, Oracle® Solaris®, Windows Server®, and Novell® NetWare®. Those of skill in the art will recognize that suitable personal computer operating systems include, by way of non-limiting examples, xft6tMicrosoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random-access memory (FRAM). In some embodiments, the non-volatile memory comprises phase-change random access memory (PRAM). In some embodiments, the non-volatile memory comprises magnetoresistive random-access memory (MRAM). In other embodiments, the device is a storage device including, by way of non-limiting examples, CD-ROMs, DVDs, flash memory devices, magnetic disk drives, magnetic tapes drives, optical disk drives, and cloud computing-based storage. In further embodiments, the storage and/or memory device is a combination of devices such as those disclosed herein.

In some embodiments, the digital processing device includes a display to send visual information to a subject. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In some embodiments, the display is E-paper or E ink. In other embodiments, the display is a video projector. In still further embodiments, the display is a combination of devices such as those disclosed herein.

In some embodiments, the digital processing device includes an input device to receive information from a subject. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the platforms, media, methods and applications described herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, media, methods and applications described herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, media, methods and applications described herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of barcode, route, parcel, subject, or network information. In various embodiments, suitable databases include, by way of non-limiting examples, relational databases, non-relational databases, object-oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### Web Browser Plug-In

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### EXAMPLES

The following illustrative example is representative of embodiments of the inventions described herein and is not meant to be limiting in any way.

### Example 1

A caller, John, dials 911 to report severe flooding in his area because of excessive rain. Because the rain has not stopped, John was concerned that his neighbors in low-lying areas may have water entering their homes and may be stuck on the roof. John also reports that he was getting patchy cell phone coverage and others may unable to make emergency calls. The call taker, Mary, asks for names and location of the people whose homes may be flooded. John reports that there is an elderly man on the corner house on Elm street, who has limited mobility and requests emergency assistance for the man hoping that a patrol of the area might identify others who need help.

Mary takes down the information about the emergency from John. Mary is a social media analyst at a local public safety answering point (PSAP) serving the county where John is located. Mary has a computer console and display screens allowing her to access information over a network. On a side screen, Mary notices relevant posts from a social media analysis program or portal installed on her console. The social media analysis program receives a social media feed of relevant posts identified as falling within the geo-bounded jurisdictional area of Mary's PSAP. She notices that several of the relevant posts reports flooding and people and pets who need help. She also finds a user who is concerned that a power line near Elm and First may be at risk of being submerged. She adds the social media information in her notes and forwards to the dispatcher. Mary knows that the raw posts from social media about the flooding can be helpful for dispatch and first responders that will be responding. She selects several of the raw posts with helpful information for forwarding to dispatch by linking the posts to the emergency call using the identifier (John's phone number).

The dispatcher, Harry, receives the information about the flooding and decides to send available fire engines to the locality. Some firemen locate the elderly man stuck in a wheel chair near his house. In addition, other responders with electrical expertise were sent to address the submerged wires and to patrol the area for other downed power lines.

### Example 2

Multiple callers call into a PSAP to report a multiple car crash on I-95 with several injuries. The dispatch receives information from several call takers regarding the accident and dispatches fire, medical and police to the location. The dispatch also sends a query regarding the multi-car accident on 1-95 for social media analysis with key words such as “accident” “crash within 3 of crash” and geobounds the query to the area around I-95. Social media analysis is performed on social media feeds by filtering social media feeds using the keywords and geo-bounded location/area. The dispatch receives several relevant posts and notices that one of the users has posted a tweet: “Just saw a scary car crash on I-95 near Flushing. Looks like a chemical truck is upturned! Hope everyone survived this accident . . . ” The dispatch contacts a Hazmat team and sends the team the best available location for the tweet. The police officers block of the area before the Hazmat team locates the upturned truck and is able to contain the flammable chemical.

### Example 3

Sally makes an emergency call to report a fire in a near-by field. Mary, the call taker, prompts Sally to provide information about the location and size of the fire and any persons or pets who might affected by the fire. Sally says that there are some homes on the northwest side of the field who may be affected. Mary creates an incident ID in her CAD program and notes down information about the fire.

In the meantime, Scully, a communications specialist at the relatively large PSAP, receives result of social media analysis in the form of relevant posts and social media analytics for the geo-bounded area of the PSAP jurisdiction. Scully notices that the “fire” keyword is trending and quickly scans the latest relevant posts. Several posts discuss a fire in that field and adjoining areas. One relevant post says: “Forest fire near gas lines near Flamington. Please beware!” The communication specialist searches the CAD system for incident IDs for fires in the area. Scully locates incident ID for Sally's call and links the incident ID to the relevant post regarding the chemical factory.

The dispatch receives Mary's notes from call with Sally. In addition, he also sees the post about the chemical factory and obtains information from various sources about gas lines. Firemen are sent to the field to stop the spread of fire toward the homes and gas lines. Another emergency responder is sent to turn off the gas line as a preventative measure.

### Example 3

Scully, a social media analyst for Everytown police station, is monitoring the relevant social media data for the area in near real-time. The system has an alarm when one two keywords (“active shooter” & “911”) start trending in the police station's jurisdiction. Scully reviews the relevant posts and social media analytics including trending, intensity, voracity, etc. Scully determines that the active shooting incident is likely occurring, and it rises to the level of likely emergency that a patrol should be sent to check it out.

Scully checks the CAD software to see if there any shootings that are being responded to in the area. When she finds no such incident, she realizes that social media might has detected the shooting early. She initiates a new emergency by generating a new incident ID in CAD and links the relevant posts. Using some of the posts, she also determines a likely location for the shooting. The dispatch receives the relevant posts and likely location and sends information to vehicle console in the police patrol car.

A few minutes later, Scully updates the social media search and finds a relevant post “Shooting at grocery store! I saw the shooter get in Red Dodge with Illinois license plate.” Scully checks the analytics and sees that there is a high veracity score, indicating a low chance that the post was from a Bot. She decides to pass on the information to the patrols in the area to look out for a Red Dodge. The suspect did not go far before a patrol car locates the car speeding in a school zone, and the suspect is quickly apprehended.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An emergency assistance system (EAS) comprising a processor, a memory, and non-transitory computer readable medium including instructions executable by the processor to create a software application for producing relevant social media data for emergency response, the application comprising:
(a) a software module accessing a social media feed comprising a plurality of posts published on a social media network by at least one user;
(b) a software module analyzing the social media feed to identify the relevant social media data determined to be pertinent to at least one current emergency situation, wherein the relevant social media data comprises one or more relevant posts from the plurality of posts;
(c) a software module associating the relevant posts to an incident that corresponds to the at least one current emergency situation and is tracked using computer aided dispatch (CAD); and
(d) a software module providing the relevant posts to an emergency service provider (ESP) user via a browser window.

2. The system of claim 1, wherein the browser window is a full window or a mini window.

3. The system of claim 2, wherein the mini window is an I-frame, AJAX, or HTML5.

4. The system of claim 3, wherein the I-frame is accessible on one or more responder devices by one or more emergency responders responding to the at least one current emergency situation.

5. The system of claim 1, further comprising a software module determining an affected area of the incident by analyzing location of relevant posts, wherein the incident is a new CAD incident ID that is associated with a mass casualty incident.

6. The system of claim 1, wherein the incident is an existing incident tracked using CAD, and associating the relevant posts to the incident comprises linking the relevant posts to the existing incident.

7. The system of claim 1, wherein associating the relevant posts to an incident comprises generating a new incident for CAD.

8. The system of claim 1, wherein analyzing the social media feed to identify relevant social media data comprises processing the social media feed using a machine learning algorithm trained with supervised learning.

9. The system of claim 1, wherein the relevant social media data is selected by a social media analyst for forwarding to at least one of a call taker, dispatcher, or responder who is responding to the at least one current emergency situation.

10. The system of claim 1, wherein the software module analyzing the social media data in (b) performs steps comprising:
(i) filtering the social media feed using geo-bounding and keywords to generate a filtered feed comprising filtered posts; and
(ii) processing the filtered feed to produce the relevant social media data by analyzing the filtered posts to identify relevant posts based on one or more of bots, emotion, categorization, location, named entity recognition (NER), intensity, trend, veracity, tagging, and part-of-speech (POS) tagging.

11. The system of claim 10, wherein geo-bounding comprises analyzing at least one of check-in location, device-based location services, IP address, user selected location, or stored address.

12. The system of claim 10, wherein analyzing the social media data comprises natural language processing (NLP) by performing text summarization on a filtered post.

13. The system of claim 10, wherein filtering the social media feed in (b) (ii) comprises geo-bounding the social media feed to a geo-bounded area corresponding to the geographical jurisdiction of the organization of the ESP user, wherein the ESP user is a member of a PSAP.

14. A computer-implemented method for producing relevant social media data for emergency response, comprising:
(a) accessing a social media feed comprising a plurality of posts published on a social media network by at least one user;
(b) analyzing the social media feed to identify the relevant social media data determined to be pertinent to at least one current emergency situation, wherein the relevant social media data comprises one or more relevant posts from the plurality of posts;
(c) associating the relevant posts to an incident that corresponds to the at least one current emergency situation and is tracked using computer aided dispatch (CAD); and
(d) providing the relevant posts to an emergency service provider (ESP) user via a browser window.

15. The method of claim 14, wherein the relevant posts comprise information associated with at least one current emergency comprising one or more of photo, video feed, audio, latitude-longitude coordinates, physical address, check-ins, chat message, or status update.

16. The method of claim 14, further comprising:
(a) receiving an emergency data request from the ESP; and
(b) securely transmitting emergency data associated with the incident to the ESP in response to receiving the emergency data request, wherein the emergency data comprises the relevant posts.

17. The method of claim 16, wherein the emergency data further comprises sensor data, location data, medical or health data, or any combination thereof

18. The method of claim 17, wherein:
(a) the emergency data request comprises credentials associated with the ESP, and
(b) transmitting the relevant social media data to an ESP further comprises verifying the credentials associated with the ESP before securely transmitting the emergency data.

19. The method of claim 14, wherein analyzing the social media data in (b) comprises:
(i) filtering the social media feed using geo-bounding and keywords to generate a filtered feed comprising filtered posts; and
(ii) processing the filtered feed to produce the relevant social media data by analyzing the filtered posts to identify relevant posts based on one or more of bots, emotion, categorization, location, named entity recognition (NER), intensity, trend, veracity, tagging, and part-of-speech (POS) tagging.

20. The method of claim 19, wherein geo-bounding comprises analyzing at least one of check-in location, device-based location services, IP address, user selected location, or stored address.
